(19) United States
(12) Patent Application Publication
(10) Pub. No.: US 2025/0206033 A1
(43) Pub. Date: Jun. 26, 2025

(54) LIQUID EJECTING APPARATUS AND CONTROL METHOD FOR LIQUID EJECTING APPARATUS

(71) Applicant: SEIKO EPSON CORPORATION, Tokyo (JP)

(72) Inventors: Akira MIYAGISHI, SHIOJIRI-SHI (JP); Hiroaki OKUI, AZUMINO-SHI (JP)

(21) Appl. No.: 18/991,907

(22) Filed: Dec. 23, 2024

(30) Foreign Application Priority Data
Dec. 26, 2023 (JP) 2023-219006

(51) Int. Cl. B41J 2/195; B41J 2/175; B41J 2/18; B41J 2/19

(52) U.S. Cl. CPC B41J 2/195; B41J 2/175; B41J 2/18; B41J 2/19

(57) ABSTRACT

A liquid ejecting apparatus includes a determination unit that determines an ejection state of the nozzle based on residual vibration generated in the pressure chamber after a voltage is applied to the piezoelectric element, a circulation mechanism that circulates the ink from the common flow path to the other common flow path via the plurality of individual flow paths, and a recovery control portion that executes a recovery process of recovering the ejection state of the nozzle to a normal state by controlling the circulation mechanism when the ejection state of the nozzle has an abnormality. The recovery control portion executes different processes according to a type of the abnormality determined by the determination unit as the recovery process.

The present application is based on, and claims priority from JP Application Serial Number 2023-219006, filed Dec. 26, 2023, the disclosure of which is hereby incorporated by reference herein in its entirety.

### BACKGROUND

### 1. Technical Field

The present disclosure relates to a liquid ejecting apparatus and a control method for the liquid ejecting apparatus.

### 2. Related Art

A liquid ejecting apparatus such as an ink jet printer ejects a liquid from a liquid ejecting head after the liquid ejecting head is filled with the liquid such as an ink. In such a liquid ejecting head, in order to prevent retention of air bubbles in the liquid and thickening of the liquid, a technique of circulating the liquid in a flow path provided in the liquid ejecting head is proposed. For example, JP-A-2021-24082 discloses a liquid ejecting apparatus having a circulation mechanism that circulates an ink discharged from a liquid ejecting head in the liquid ejecting head.

In addition, in a liquid ejecting head that ejects a liquid from a nozzle by using a piezoelectric element, a technique for determining an ejection state of the nozzle based on residual vibration generated in a pressure chamber communicating with the nozzle after a voltage is applied to the piezoelectric element is proposed. For example, JP-A-2004-314459 discloses a liquid droplet ejecting apparatus including a head unit including a plurality of liquid droplet ejecting heads having a diaphragm, an actuator, and a cavity, and a head abnormality detection section that detects residual vibration of the diaphragm, and detects a head abnormality of the liquid droplet ejecting head based on a vibration pattern of the residual vibration.

In the liquid ejecting apparatus that circulates the liquid in the flow path provided in the liquid ejecting head, it is considered that an ejection state is recovered to a normal state by the circulation of the liquid even when the ejection state of the nozzle is in an abnormal state. Meanwhile, according to the investigation of the present inventor, it is found that it is necessary to adjust circulation of a liquid depending on a type of abnormality in an ejection state of a nozzle.

### SUMMARY

According to an aspect of the present disclosure, there is provided a liquid ejecting apparatus including: a piezoelectric element; a plurality of individual flow paths each including a pressure chamber and a nozzle for ejecting a liquid; a common supply flow path which communicates in common with the plurality of individual flow paths and through which the liquid is supplied to the plurality of individual flow paths; a common discharge flow path which communicates in common with the plurality of individual flow paths and through which the liquid is discharged from the plurality of individual flow paths; a state determination portion that determines an ejection state of the nozzle, based on residual vibration generated in the pressure chamber after a voltage is applied to the piezoelectric element; a circulation portion that circulates the liquid from the common supply flow path to the common discharge flow path via the plurality of individual flow paths; and a recovery control portion that executes a recovery process of recovering the ejection state of the nozzle to a normal state by controlling the circulation portion when the ejection state of the nozzle has an abnormality, in which the recovery control portion executes different processes according to a type of the abnormality determined by the state determination portion, as the recovery process.

According to another aspect of the present disclosure, there is provided a control method for a liquid ejecting apparatus including a piezoelectric element, a plurality of individual flow paths each including a pressure chamber and a nozzle for ejecting a liquid, a common supply flow path which communicates in common with the plurality of individual flow paths and through which the liquid is supplied to the plurality of individual flow paths, a common discharge flow path which communicates in common with the plurality of individual flow paths and through which the liquid is discharged from the plurality of individual flow paths, a state determination portion that determines an ejection state of the nozzle, based on residual vibration generated in the pressure chamber after a voltage is applied to the piezoelectric element, and a circulation portion that circulates the liquid from the common supply flow path to the common discharge flow path via the plurality of individual flow paths, the method including: executing a recovery process of recovering the ejection state of the nozzle to a normal state by controlling the circulation portion when the ejection state of the nozzle has an abnormality, in which the recovery process is a process that differs according to a type of the abnormality determined by the state determination portion.

### BRIEF DESCRIPTION OF THE DRAWINGS

FIG. 1 is a block diagram illustrating an example of a configuration of a liquid ejecting apparatus according to an embodiment of the present disclosure.

FIG. 2 is a configuration diagram schematically illustrating the liquid ejecting apparatus.

FIG. 3 is an exploded perspective view of a liquid ejecting head.

FIG. 4 is a cross-sectional diagram taken along a line IV-IV in FIG. 3.

FIG. 5 is an explanatory diagram describing a flow of an ink.

FIG. 6 is a block diagram illustrating an example of a configuration of the liquid ejecting head.

FIG. 7 is a timing chart illustrating an example of an operation of the liquid ejecting apparatus in a unit period.

FIG. 8 is an explanatory diagram describing an operation of a determination unit.

FIG. 9 is a flowchart illustrating an example of a first recovery process.

FIG. 10 is a flowchart illustrating an example of a second recovery process.

FIG. 11 is a flowchart illustrating an example of a third recovery process.

### DESCRIPTION OF EMBODIMENTS

Hereinafter, embodiments for carrying out the present disclosure will be described with reference to the drawings. Meanwhile, in each drawing, the size and scale of each portion are appropriately different from the actual ones. The embodiments described below are preferred specific examples of the present disclosure and thus have technically preferred various limitations, but the scope of the present disclosure is not limited to such embodiments unless description for limiting the present disclosure is made in the following description.

### 1. EMBODIMENT

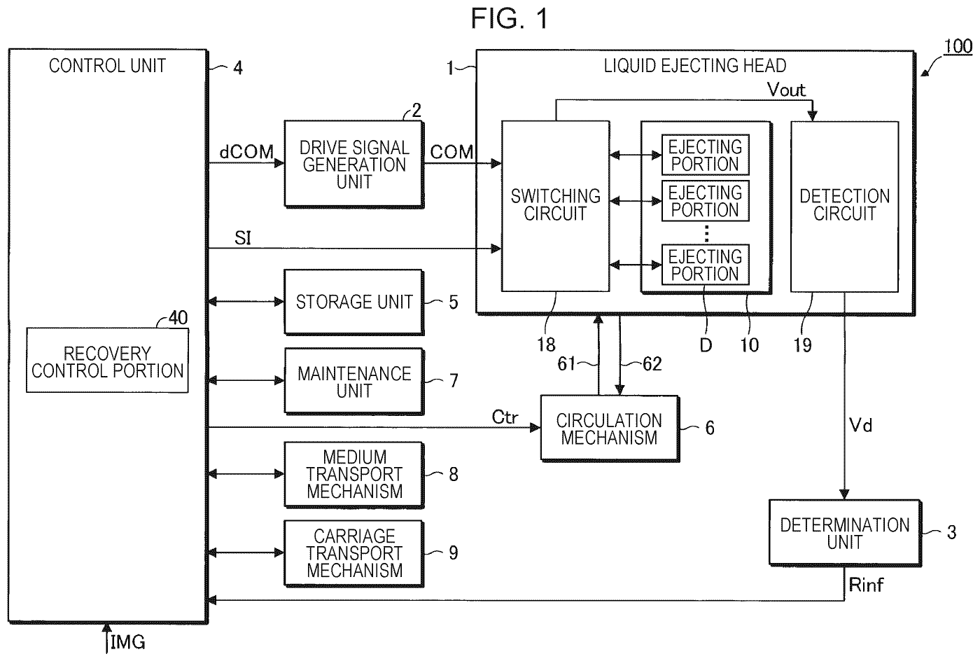

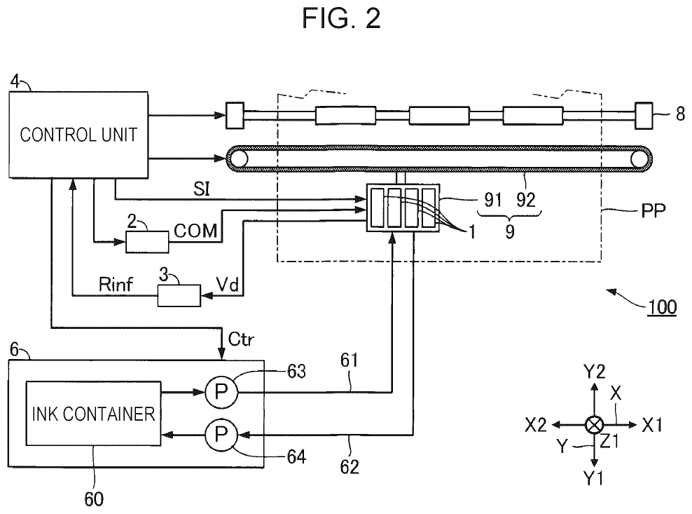

First, an outline of a liquid ejecting apparatus 100 according to the present embodiment will be described with reference to FIG. 1. In the present embodiment, it is assumed that the liquid ejecting apparatus 100 is an ink jet printer that ejects an ink to a medium PP to form an image, as an example. In the present embodiment, a recording paper illustrated in FIG. 2 to be described below is assumed as the medium PP.

FIG. 1 is a block diagram illustrating an example of a configuration of the liquid ejecting apparatus 100 according to an embodiment of the present disclosure.

For example, print data IMG indicating an image to be formed by the liquid ejecting apparatus 100 is supplied to the liquid ejecting apparatus 100 from a host computer such as a personal computer or a digital camera. The liquid ejecting apparatus 100 executes a printing process of forming the image indicated by the print data IMG supplied from the host computer on the medium PP.

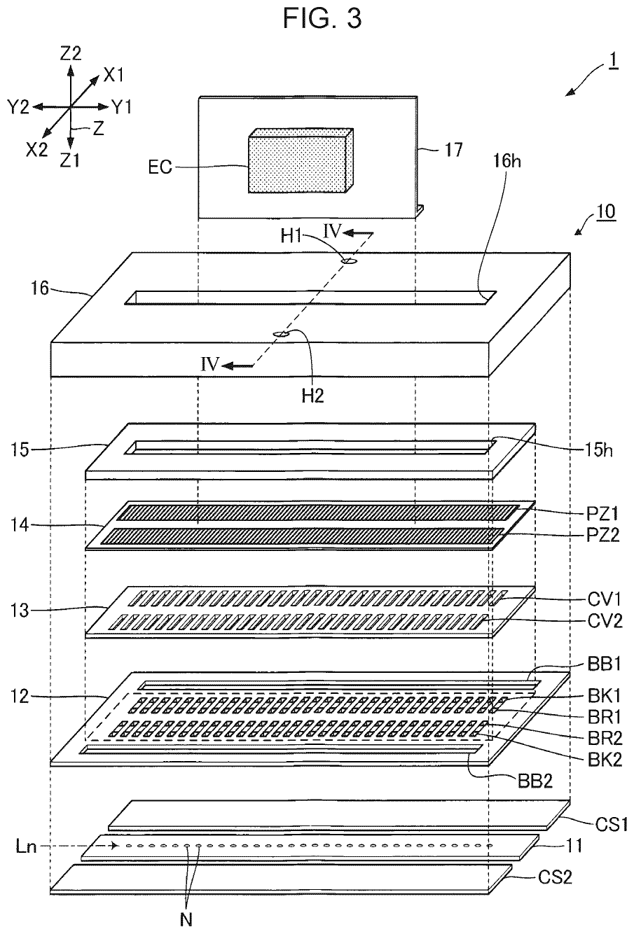

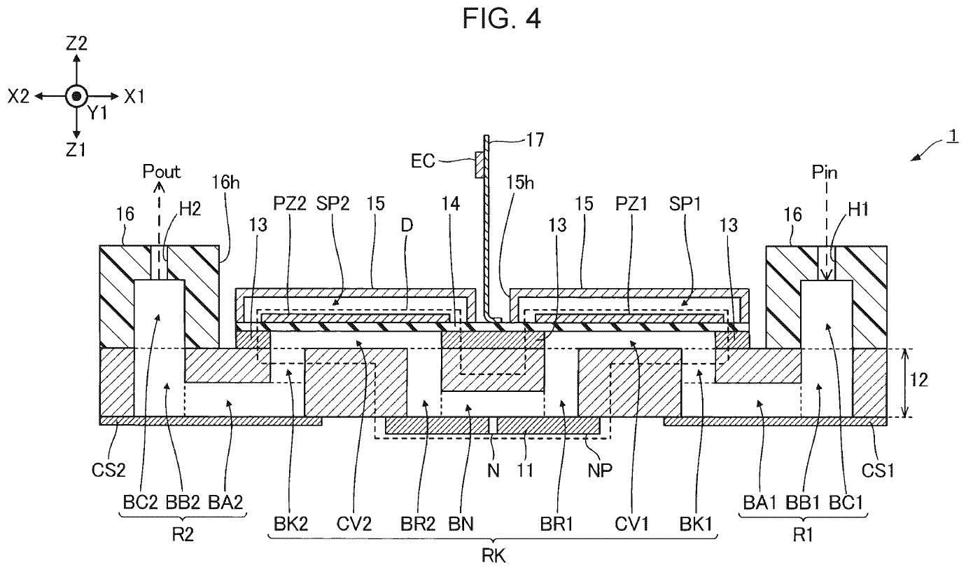

The liquid ejecting apparatus 100 includes a liquid ejecting head 1 provided with an ejecting portion D including a nozzle N that ejects an ink, a drive signal generation unit 2 that generates a plurality of drive signals COM for driving the ejecting portion D, and a determination unit 3 that determines an ejection state of the nozzle N. The nozzles N will be described below with reference to FIGS. 3 and 4. Further, the liquid ejecting apparatus 100 includes a control unit 4 that controls each portion of the liquid ejecting apparatus 100, and a storage unit 5 that stores various types of information such as the print data IMG and a control program of the liquid ejecting apparatus 100. Further, the liquid ejecting apparatus 100 includes a circulation mechanism 6 that circulates the ink, a maintenance unit 7 that executes a maintenance process on the liquid ejecting head 1, a medium transport mechanism 8 that transports the medium PP, and a carriage transport mechanism 9 that reciprocates a carriage 91. The carriage 91 will be described below with reference to FIG. 2. The determination unit 3 is an example of a “state determination portion”, and the circulation mechanism 6 is an example of a “circulation machine portion”.

In the present embodiment, a case is assumed in which the liquid ejecting head 1 and the drive signal generation unit 2 correspond to each other, the liquid ejecting head 1 and the determination unit 3 correspond to each other, and the liquid ejecting head 1 and the circulation mechanism 6 correspond to each other. For example, the liquid ejecting apparatus 100 may include a plurality of liquid ejecting heads 1, a plurality of drive signal generation units 2, a plurality of determination units 3, and a plurality of circulation mechanisms 6. In this case, for example, the plurality of drive signal generation units 2 correspond to the plurality of liquid ejecting heads 1 on a one-to-one basis, the plurality of determination units 3 correspond to the plurality of liquid ejecting heads 1 on a one-to-one basis, and the plurality of circulation mechanisms 6 correspond to the plurality of liquid ejecting heads 1 on a one-to-one basis. Alternatively, the liquid ejecting apparatus 100 may include one liquid ejecting head 1, one drive signal generation unit 2 corresponding to the liquid ejecting head 1, one determination unit 3 corresponding to the liquid ejecting head 1, and one circulation mechanism 6 corresponding to the liquid ejecting head 1.

In the present embodiment, a case is assumed in which the liquid ejecting apparatus 100 has four liquid ejecting heads 1 respectively corresponding to four types of an ink of cyan, magenta, yellow, and black. That is, in the present embodiment, a case is assumed in which the liquid ejecting apparatus 100 includes four liquid ejecting heads 1, four drive signal generation units 2, four determination units 3, and four circulation mechanisms 6. Meanwhile, in the following, for convenience of description, as illustrated in FIG. 1, one liquid ejecting head 1 of the four liquid ejecting heads 1, one drive signal generation unit 2 corresponding to the one liquid ejecting head 1, one determination unit 3, and one circulation mechanism 6 may be focused on and described.

First, the control unit 4, the drive signal generation unit 2, and the storage unit 5 will be described before the liquid ejecting head 1 is to be described.

The control unit 4 is configured with one or a plurality of central processing units (CPU). The control unit 4 may be configured with a programmable logic device such as a field-programmable gate array (FPGA), instead of the CPU or in addition to the CPU. Further, for example, the control unit 4 generates a signal for controlling an operation of each portion of the liquid ejecting apparatus 100, such as a print signal SI and a waveform designation signal dCOM, by operating according to a control program stored in the storage unit 5.

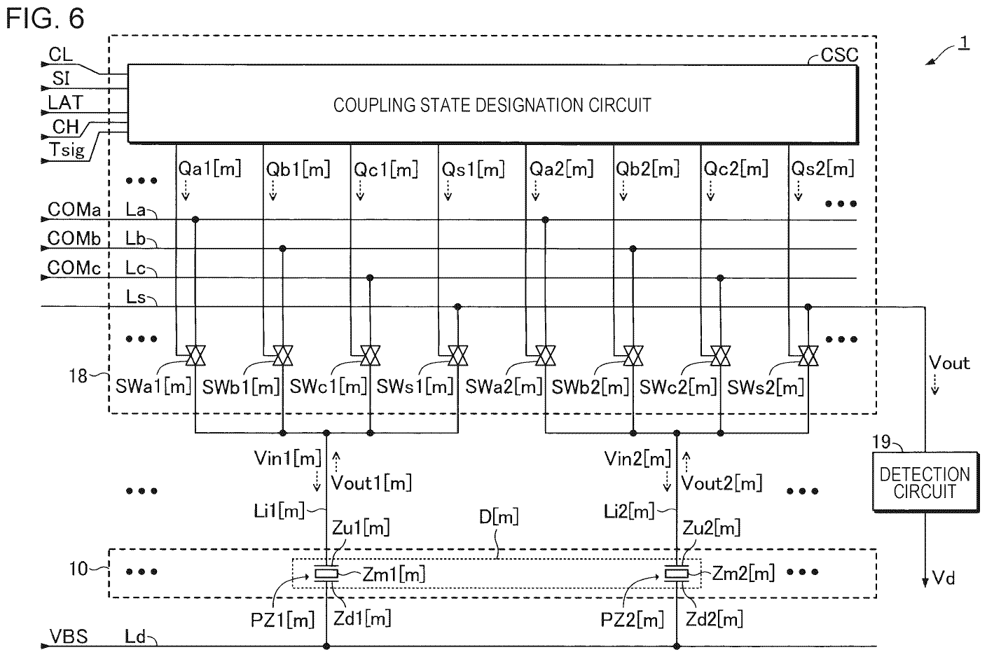

Here, the waveform designation signal dCOM is a digital signal that defines each of waveforms of the plurality of drive signals COM. In addition, each drive signal COM is an analog signal used to drive the ejecting portion D. In the present embodiment, as illustrated in FIG. 6 and the like to be described below, a case is assumed in which the plurality of drive signals COM include drive signals COMa and COMb, and a drive signal COMc. The print signal SI is a digital signal for designating a type of operation of the ejecting portion D. Specifically, the print signal SI is a signal for designating the type of operation of the ejecting portion D by designating whether or not to supply each drive signal COM to the ejecting portion D.

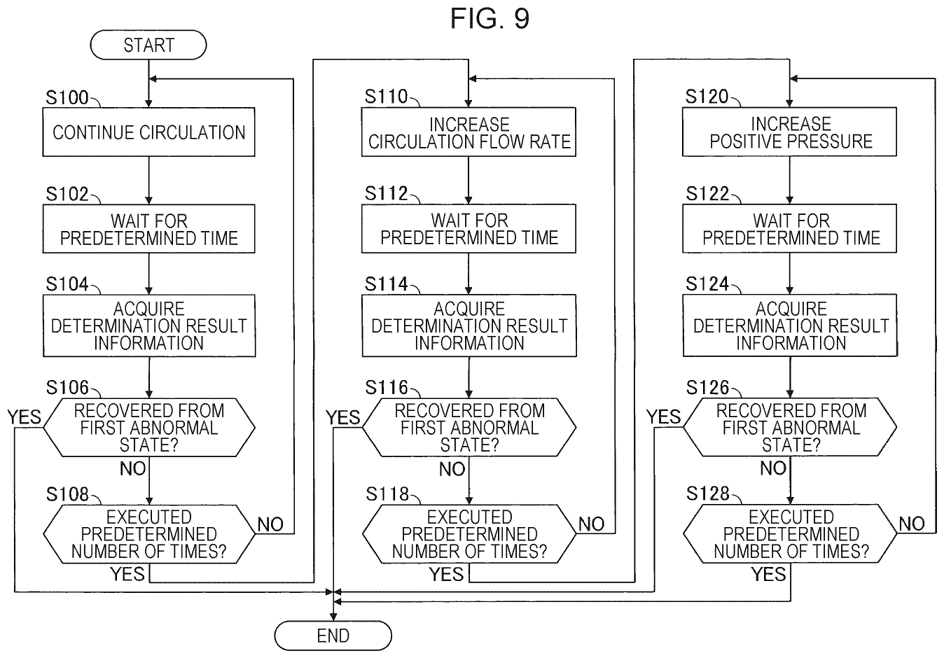

In the present embodiment, the control unit 4 functions as a recovery control portion 40 by operating according to the control program stored in the storage unit 5. The recovery control portion 40 executes a recovery process of recovering the ejection state of the nozzle N to a normal state by controlling the circulation mechanism 6 when, for example, the ejection state of the nozzle N illustrated in FIG. 3 and the like, which will be described below, has an abnormality. In the present embodiment, the recovery control portion 40 executes different processes according to a type of abnormality in the ejection state determined by the determination unit 3 as the recovery process. Details of the recovery process will be described with reference to FIGS. 9, 10, and 11.

The drive signal generation unit 2 includes, for example, a digital analog converter (DAC), and generates the plurality of drive signals COM based on the waveform designation signal dCOM supplied from the control unit 4. For example, each of the plurality of drive signals COM generated by the drive signal generation unit 2 includes a waveform defined by the waveform designation signal dCOM. The drive signal generation unit 2 outputs the plurality of drive signals COM generated based on the waveform designation signal dCOM to a switching circuit 18 included in the liquid ejecting head 1.

The storage unit 5 is configured to include one or both of a volatile memory such as a random access memory (RAM), and a non-volatile memory such as a read only memory (ROM), an electrically erasable programmable read-only memory (EEPROM), or a programmable ROM (PROM). The storage unit 5 may be included in the control unit 4.

The liquid ejecting head 1 includes the switching circuit 18, a recording head 10, and a detection circuit 19.

The recording head 10 includes M ejecting portions D. A value of M is a natural number of 1 or more. Hereinafter, among the M ejecting portions D provided in the recording head 10, an m-th ejecting portion D may be referred to as an ejecting portion D[m]. In this case, the variable m is a natural number that satisfies “1≤m≤M”. Further, in the following, when a component, a signal, or the like of the liquid ejecting apparatus 100 corresponds to the ejecting portion D[m] among the M ejecting portions D, the subscript [m] may be added to the reference numerals for representing the component, the signals, or the like.

The switching circuit 18 switches whether or not to supply each drive signal COM to the ejecting portion D[m], based on the print signal SI. In the following, as illustrated in FIG. 6 and the like to be described below, the drive signal COM supplied to the ejecting portion D[m] among the plurality of drive signals COM may be referred to as an individual drive signal Vin[m]. Further, the switching circuit 18 switches whether or not to electrically couple the ejecting portion D[m] and the detection circuit 19 based on the print signal SI. When the ejecting portion D[m] and the detection circuit 19 are electrically coupled to each other, for example, a detection signal Vout[m] detected from the ejecting portion D[m] is supplied to the detection circuit 19 via the switching circuit 18.

The detection circuit 19 generates a residual vibration signal Vd[m] based on the detection signal Vout[m]. For example, the detection circuit 19 amplifies an amplitude of the detection signal Vout[m] or removes a noise component included in the detection signal Vout[m] to shape the detection signal Vout[m] into a waveform appropriate for a process in the determination unit 3. Therefore, the residual vibration signal Vd[m] is generated. For example, the detection circuit 19 may have a configuration including a negative feedback type amplifier for amplifying the detection signal Vout[m], a low-pass filter for attenuating a high-frequency component of the detection signal Vout[m], and a voltage follower that converts an impedance and outputs a low-impedance residual vibration signal Vd[m].

The detection circuit 19 outputs the residual vibration signal Vd[m] generated based on the detection signal Vout[m] to the determination unit 3.

The determination unit 3 determines, for example, the ejection state of the nozzle N included in the ejecting portion D[m] based on the residual vibration signal Vd[m]. For example, the residual vibration signal Vd[m] used to determine the ejection state of the nozzle N included in the ejecting portion D[m] indicates a waveform of residual vibration, which is vibration remaining in the ejecting portion D[m] after the ejecting portion D[m] is driven by the individual drive signal Vin[m].

For example, the determination unit 3 determines the ejection state of the nozzle N by comparing detection values such as an amplitude and a cycle of the residual vibration signal Vd[m] with a reference value when the ejection state of the nozzle N is normal. Then, the determination unit 3 generates determination result information Rinf including, for example, information indicating the ejection state of the nozzle N, and outputs the generated determination result information Rinf to the control unit 4. The ejection state of the nozzle N includes, for example, a normal state, a first abnormal state caused by mixing of air bubbles into the nozzle N, a second abnormal state caused by thickening of the ink in the nozzle N, a third abnormal state caused by a leakage of the ink from the nozzle N, and the like. For example, when the determination result information Rinf indicates any of the first abnormality, the second abnormality, and the third abnormality, the recovery control portion 40 executes a recovery process of recovering the ejection state of the nozzle N to the normal state based on the type of the abnormality indicated by the determination result information Rinf. The determination unit 3 may be included in the control unit 4. For example, the control unit 4 may function as the determination unit 3 by operating according to the control program stored in the storage unit 5.

Further, in the present embodiment, as described above, the maintenance process is executed by the maintenance unit 7. For example, the maintenance unit 7 executes the maintenance process under the control of the control unit 4. For example, the maintenance process includes flushing processing of discharging inks from the ejecting portion D, wiping processing of wiping off a foreign matter such as an ink adhering to the vicinity of a nozzle N of the ejecting portion D with a wiper, and pumping processing of suctioning the ink in the ejecting portion D with a tube pump or the like.

The maintenance unit 7 includes a discharge ink receiving portion for receiving the discharged ink when the ink in the ejecting portion D is discharged, a wiper for wiping off a foreign matter such as an ink adhering to the vicinity of the nozzle N of the ejecting portion D, and a tube pump for suctioning the ink, air bubbles, and the like in the ejecting portion D, in the flushing processing. The discharge ink receiving portion, the wiper, and the tube pump are not illustrated.

Next, a schematic overall configuration of the liquid ejecting apparatus 100 will be described with reference to FIG. 2.

FIG. 2 is a configuration diagram schematically illustrating the liquid ejecting apparatus 100. In FIG. 2, the circulation mechanism 6, the medium transport mechanism 8, and the carriage transport mechanism 9 will be mainly described.

The circulation mechanism 6 supplies an ink stored in the circulation mechanism 6 to the liquid ejecting head 1 based on a control signal Ctr supplied from the control unit 4. Further, the circulation mechanism 6 collects the ink from the liquid ejecting head 1 based on the control signal Ctr supplied from the control unit 4, and returns the collected ink to the liquid ejecting head 1.

For example, the circulation mechanism 6 includes an ink container 60 that stores inks, a pump 63 coupled to a supply flow path 61 through which the inks are supplied to the liquid ejecting head 1, and a pump 64 coupled to a collection flow path 62 through which the inks discharged from the liquid ejecting head 1 are collected. As the ink container 60, for example, a cartridge that can be attached to and detached from the liquid ejecting apparatus 100, a bag-shaped ink pack formed of a flexible film, or an ink tank that can be replenished with inks can be adopted. A type of the ink stored in the ink container 60 is not particularly limited, and is optional.

The pumps 63 and 64 are controlled by the control unit 4. For example, the pump 63 supplies the ink stored in the ink container 60 to the liquid ejecting head 1 via the supply flow path 61 based on the control signal Ctr supplied from the control unit 4. For example, the pump 64 collects the ink from the liquid ejecting head 1 via the collection flow path 62 based on the control signal Ctr supplied from the control unit 4, and supplies the collected ink to the ink container 60.

The circulation mechanism 6 may be defined without including the ink container 60, or may be defined to include the supply flow path 61 and the collection flow path 62.

The medium transport mechanism 8 transports the medium PP in a Y1 direction along a Y-axis under the control of the control unit 4. Hereinafter, the Y1 direction and a Y2 direction opposite to the Y1 direction are collectively referred to as a Y-axis direction. In addition, hereinafter, an X1 direction along an X-axis that intersects the Y-axis and an X2 direction opposite to the X1 direction are collectively referred to as an X-axis direction. In addition, hereinafter, a Z1 direction along a Z-axis that intersects the X-axis and the Y-axis and a Z2 direction opposite to the Z1 direction are collectively referred to as a Z-axis direction. In the present embodiment, as an example, description will be performed by assuming that the X-axis, the Y-axis, and the Z-axis are orthogonal to each other. Meanwhile, the present disclosure is not limited to such an aspect. The X-axis, the Y-axis, and the Z-axis may intersect each other.

The carriage transport mechanism 9 reciprocates the plurality of liquid ejecting heads 1 in the X1 direction and the X2 direction under the control of the control unit 4. As illustrated in FIG. 2, the carriage transport mechanism 9 includes the substantially box-shaped carriage 91 that accommodates the plurality of liquid ejecting heads 1, and an endless belt 92 to which the carriage 91 is fixed. The circulation mechanism 6 may be stored in the carriage 91 together with the liquid ejecting head 1.

The liquid ejecting head 1 is driven by the drive signal COM under the control of the print signal SI, and ejects the ink in the Z1 direction from some or all of the plurality of nozzles N provided in the liquid ejecting head 1. That is, the liquid ejecting head 1 forms a desired image on a surface of the medium PP by ejecting the ink from the some or all of the plurality of nozzles N in conjunction with transport of the medium PP by the medium transport mechanism 8 and a reciprocating motion of the liquid ejecting head 1 by the carriage transport mechanism 9 and landing the ejected ink on the surface of the medium PP.

Next, a schematic structure of the liquid ejecting head 1 will be described with reference to FIGS. 3 and 4.

FIG. 3 is an exploded perspective view of the liquid ejecting head 1. FIG. 4 is a cross-sectional diagram taken along a line IV-IV illustrated in FIG. 3. A cross section taken along the line IV-IV is parallel to the XZ plane and passes through coupling ports H1 and H2 to be described below.

As illustrated in FIGS. 3 and 4, the liquid ejecting head 1 includes a nozzle substrate 11, compliance sheets CS1 and CS2, a communication plate 12, a pressure chamber substrate 13, a diaphragm 14, a sealing substrate 15, a flow path forming substrate 16, and a wiring substrate 17 at which an electronic component EC is mounted. The electronic component EC includes, for example, an electric circuit such as the switching circuit 18 and the detection circuit 19. For example, the recording head 10 is electrically coupled to the switching circuit 18, the detection circuit 19, and the like via the wiring substrate 17.

As illustrated in FIG. 3, the recording head 10 includes, for example, the nozzle substrate 11, the compliance sheets CS1 and CS2, the communication plate 12, the pressure chamber substrate 13, the diaphragm 14, the sealing substrate 15, and the flow path forming substrate 16.

The nozzle substrate 11 is a plate-shaped member elongated in the Y-axis direction and extending substantially parallel to an XY plane. Here, “substantially parallel” is a concept that includes not only a case of being completely parallel but also a case of being considered to be parallel when an error is considered. In the present embodiment, “substantially parallel” is a concept that includes a case where it can be regarded as parallel when an error of approximately 10% is considered. The “substantially vertical” described below is also a concept that includes a case where it is considered to be vertical when an error is taken into consideration, in addition to a case where it is completely vertical, as in the case of the “substantially parallel”.

M nozzles N are formed at the nozzle substrate 11. Here, the nozzle N is a through-hole provided in the nozzle substrate 11. In the present embodiment, a case is assumed in which the M nozzles N are arranged at the nozzle substrate 11 to extend in the Y-axis direction. Hereinafter, the M nozzles N extending in the Y-axis direction may be referred to as a nozzle row Ln.

The nozzle substrate 11 is manufactured, for example, by processing a silicon single crystal substrate using a semiconductor manufacturing technology such as etching, and any known material and manufacturing method may be adopted to manufacture the nozzle substrate 11.

As illustrated in FIGS. 3 and 4, the communication plate 12 is provided at a position in the Z2 direction with respect to the nozzle substrate 11. The communication plate 12 is a plate-shaped member elongated in the Y-axis direction and extending substantially parallel to the XY plane. The communication plate 12 is manufactured, for example, by processing a silicon single crystal substrate using semiconductor manufacturing technology, and any known material and manufacturing method may be adopted to manufacture the communication plate 12.

A flow path for inks is formed in the communication plate 12. Specifically, the communication plate 12 is formed with one common flow path BB1 provided to extend in the Y-axis direction and one common flow path BB2 provided to extend in the Y-axis direction. The common flow path BB2 is located in the X2 direction with respect to the common flow path BB1. In addition, the communication plate 12 is formed with one common flow path BA1 provided to extend in the Y-axis direction and one common flow path BA2 provided to extend in the Y-axis direction. Although the common flow path BA1 and the common flow path BA2 are not illustrated in FIG. 3, the common flow path BA1 and the common flow path BA2 are located between the common flow path BB1 and the common flow path BB2 as illustrated in FIG. 4. The common flow path BA2 is located between the common flow path BA1 and the common flow path BB2.

In addition, the communication plate 12 is formed with M coupling flow paths BK1 corresponding to the M nozzles N, M coupling flow paths BK2 corresponding to the M nozzles N, M coupling flow paths BR1 corresponding to the M nozzles N, and M coupling flow paths BR2 corresponding to the M nozzles N. Further, as illustrated in FIG. 4, the communication plate 12 is formed with M nozzle flow paths BN corresponding to M nozzles N.

As illustrated in FIG. 4, the coupling flow path BK1 is provided at a position, which is a position in the X2 direction with respect to the common flow path BB1 and in the Z2 direction with respect to the common flow path BA1, to extend in the Z-axis direction, and communicates with the common flow path BA1. The coupling flow path BR1 is provided at a position in the X2 direction with respect to the coupling flow path BK1 to extend in the Z-axis direction. The coupling flow path BK2 is provided at a position, which is a position in the X1 direction with respect to the common flow path BB2 and in the Z2 direction with respect to the common flow path BA2, to extend in the Z-axis direction, and communicates with the common flow path BA2. The coupling flow path BR2 is provided at a position in the X1 direction with respect to the coupling flow path BK2 to extend in the Z-axis direction. The coupling flow path BR2 is located in the X2 direction with respect to the coupling flow path BR1. The nozzle flow path BN is located between the coupling flow path BR1 and the coupling flow path BR2, and communicates with the coupling flow path BR1 and the coupling flow path BR2. Further, the nozzle flow path BN communicates with the nozzle N corresponding to the nozzle flow path BN.

In the following, the common flow paths BA1 and BA2 may be collectively referred to as a common flow path BA, and the common flow paths BB1 and BB2 may be collectively referred to as a common flow path BB. Further, in the following, the coupling flow paths BK1 and BK2 may be collectively referred to as a coupling flow path BK, and the coupling flow paths BR1 and BR2 may be collectively referred to as a coupling flow path BR.

As illustrated in FIGS. 3 and 4, the pressure chamber substrate 13 is provided at a position in the Z2 direction with respect to the communication plate 12. The pressure chamber substrate 13 is a plate-shaped member elongated in the Y-axis direction and extending substantially parallel to the XY plane. The pressure chamber substrate 13 is manufactured, for example, by processing a silicon single crystal substrate using semiconductor manufacturing technology, and any known material and manufacturing method may be adopted to manufacture the pressure chamber substrate 13.

A flow path for inks is formed in the pressure chamber substrate 13. Specifically, the pressure chamber substrate 13 is formed with M pressure chambers CV1 corresponding to the M nozzles N and M pressure chambers CV2 corresponding to the M nozzles N. The pressure chamber CV1 is located in the Z2 direction with respect to the coupling flow path BK1 and the coupling flow path BR1, and is provided to extend in the X-axis direction to communicate with the coupling flow path BK1 and the coupling flow path BR1. The pressure chamber CV2 is located in the Z2 direction with respect to the coupling flow path BK2 and the coupling flow path BR2, and is provided to extend in the X-axis direction to communicate with the coupling flow path BK2 and the coupling flow path BR2. In the following, the pressure chambers CV1 and CV2 may be collectively referred to as a pressure chamber CV.

Hereinafter, the coupling flow path BK1, the pressure chamber CV1 communicating with the coupling flow path BK1, the coupling flow path BR1 communicating with the pressure chamber CV1, the nozzle flow path BN communicating with the coupling flow path BR1, the coupling flow path BR2 communicating with the nozzle flow path BN, the pressure chamber CV2 communicating with the coupling flow path BR2, and the coupling flow path BK2 communicating with the pressure chamber CV2 may be referred to as an individual flow path RK. In addition, in the following, the individual flow path RK corresponding to the m-th nozzle N among the M nozzles N may be referred to as an individual flow path RK[m]. In the present embodiment, the individual flow path RK[m] is defined to include the m-th nozzle N among the M nozzles N. That is, in the present embodiment, the individual flow path RK[m] has the m-th nozzle N and the pressure chamber CV corresponding to the m-th nozzle N. In the present embodiment, the M individual flow paths RK[1] to RK[M] are disposed along the Y-axis direction.

As illustrated in FIGS. 3 and 4, the diaphragm 14 is provided at a position in the Z2 direction with respect to the pressure chamber substrate 13. The diaphragm 14 is a plate-shaped member elongated in the Y-axis direction and extending substantially parallel to the XY plane, and is a member that can vibrate elastically. The diaphragm 14 has, for example, an elastic film made of silicon oxide and an insulator film made of zirconium oxide. The elastic film of the diaphragm 14 is not limited to the elastic film made of silicon oxide. In the same manner, the insulator film included in the diaphragm 14 is not limited to the insulator film made of zirconium oxide.

As illustrated in FIGS. 3 and 4, on a surface of the diaphragm 14 in the Z2 direction, M piezoelectric elements PZ1 corresponding to the M pressure chambers CV1 and M piezoelectric elements PZ2 corresponding to the M pressure chambers CV2 are provided. Here, a surface of an element A in a first direction is a surface of the element A, which is substantially vertical to the first direction among surfaces of the element A, and is a surface which is visible when the element A is viewed in the first direction from a second direction. The second direction is a direction opposite to the first direction. In addition, an expression “an element B is formed at the surface of the element A” in the present specification is not intended to limit the configuration to a configuration in which the element A and the element B are in direct contact with each other. That is, a configuration in which an element C is formed at the surface of the element A and the element B is formed at a surface of the element C is also included in the concept of “the element B is formed at the surface of the element A” insofar as the element A and the element B overlap at least in part in plan view.

Although not illustrated in FIGS. 3 and 4, the piezoelectric element PZ1 has a common electrode Zd1 to which a predetermined bias potential VBS is supplied, an individual electrode Zu1 to which an individual drive signal Vin1 is supplied, and a piezoelectric layer Zm1 provided between the individual electrode Zu1 and the common electrode Zd1, as illustrated in FIG. 6. For example, the common electrode Zd1, the piezoelectric layer Zm1, and the individual electrode Zu1 are provided in this order on the surface of the diaphragm 14 in the Z2 direction along the Z2 direction. In the same manner, the piezoelectric element PZ2 has a common electrode Zd2, an individual electrode Zu2, and a piezoelectric layer Zm2. Hereinafter, the piezoelectric elements PZ1 and PZ2 may be collectively referred to as a piezoelectric element PZ. In the same manner, the common electrode Zd1 and the common electrode Zd2 may be collectively referred to as a common electrode Zd, the individual electrode Zu1 and the individual electrode Zu2 may be collectively referred to as an individual electrode Zu, and the piezoelectric layers Zm1 and Zm2 may be collectively referred to as a piezoelectric layer Zm. In the present embodiment, the common electrode Zd is a so-called lower electrode, and the individual electrode Zu is a so-called upper electrode, and the common electrode Zd may be an upper electrode and the individual electrode Zu may be a lower electrode.

The piezoelectric element PZ is a passive element that is deformed in response to a potential change of the drive signal COM supplied to the individual electrode Zu as the individual drive signal Vin. Specifically, the piezoelectric element PZ is driven and deformed in response to a potential change of the drive signal COM.

As illustrated in FIGS. 3 and 4, since the piezoelectric element PZ is provided on the surface of the diaphragm 14 in the Z2 direction, the diaphragm 14 vibrates in conjunction with the deformation of the piezoelectric element PZ. When the diaphragm 14 vibrates, a pressure in the pressure chamber CV fluctuates. Then, the pressure inside the pressure chamber CV fluctuates, and the ink with which an inside of the pressure chamber CV is filled is ejected from the nozzle N via the coupling flow path BR and the nozzle flow path BN.

As illustrated in FIGS. 3 and 4, the sealing substrate 15 for protecting the M piezoelectric elements PZ1 and the M piezoelectric elements PZ2 is provided at a position in the Z2 direction with respect to the pressure chamber substrate 13. The sealing substrate 15 is a plate-shaped member elongated in the Y-axis direction and extending substantially parallel to the XY plane. The sealing substrate 15 is manufactured, for example, by processing a silicon single crystal substrate using semiconductor manufacturing technology, and any known material and manufacturing method may be adopted to manufacture the sealing substrate 15.

A surface of the sealing substrate 15 in the Z1 direction is provided with a recess portion for covering the M piezoelectric elements PZ1 and a recess portion for covering the M piezoelectric elements PZ2. Hereinafter, a sealing space covering the M piezoelectric elements PZ1 and formed between the diaphragm 14 and the sealing substrate 15 is referred to as a sealing space SP1, and a sealing space covering the M piezoelectric elements PZ2 and formed between the diaphragm 14 and the sealing substrate 15 is referred to as a sealing space SP2. In addition, in the following, the sealing spaces SP1 and SP2 may be collectively referred to as a sealing space SP. The sealing space SP is a space for sealing the piezoelectric element PZ and preventing the piezoelectric element PZ from deteriorating due to an influence of moisture or the like.

The sealing substrate 15 is provided with a through-hole 15h. The through-hole 15h is a hole that is located between the sealing space SP1 and the sealing space SP2 when the sealing substrate 15 is viewed in the Z1 direction, and penetrates from the surface of the sealing substrate 15 in the Z1 direction to the surface of the sealing substrate 15 in the Z2 direction. The wiring substrate 17 is inserted into the through-hole 15h.

As illustrated in FIGS. 3 and 4, the flow path forming substrate 16 is provided at a position in the Z2 direction with respect to the communication plate 12. The flow path forming substrate 16 is a plate-shaped member elongated in the Y-axis direction and extending substantially parallel to the XY plane. The flow path forming substrate 16 is formed by, for example, injection molding of a resin material, and any known material and manufacturing method may be adopted to manufacture the flow path forming substrate 16.

A flow path for inks is formed in the flow path forming substrate 16. Specifically, the flow path forming substrate 16 is formed with one common flow path BC1 provided to extend in the Y-axis direction and one common flow path BC2 provided to extend in the Y-axis direction. For example, as illustrated in FIG. 4, the common flow path BC1 is provided at a position in the Z2 direction with respect to the common flow path BB1, and communicates with the common flow path BB1. The common flow path BC2 is provided at a position, which is a position in the Z2 direction with respect to the common flow path BB2 and in the X2 direction with respect to the common flow path BC1, and communicates with the common flow path BB2. In the following, the common flow paths BC1 and BC2 may be collectively referred to as a common flow path BC.

Hereinafter, the common flow path BA1, the common flow path BB1 communicating with the common flow path BA1, and the common flow path BC1 communicating with the common flow path BB1 may be referred to as a common flow path R1. In addition, in the following, the common flow path BA2, the common flow path BB2 communicating with the common flow path BA2, and the common flow path BC2 communicating with the common flow path BB2 may be referred to as a common flow path R2. In addition, in the following, the common flow paths R1 and R2 may be collectively referred to as a common flow path R. The common flow path R1 is an example of a “common supply flow path”, and the common flow path R2 is an example of a “common discharge flow path”.

The flow path forming substrate 16 is provided with the coupling port H1 that communicates with the common flow path BC1 and the coupling port H2 that communicates with the common flow path BC2. The supply flow path 61 is coupled to the coupling port H1, and the collection flow path 62 is coupled to the coupling port H2. For example, the pump 63 supplies an ink from the ink container 60 to the common flow path R1 including the common flow path BC1 via the supply flow path 61 and the coupling port H1. In this case, a pressure applied to the common flow path R1 is a positive pressure Pin higher than an atmospheric pressure. For example, the pump 64 collects a part of the ink stored in the common flow path R2 including the common flow path BC2 via the collection flow path 62 and the coupling port H2, and supplies the collected ink to the ink container 60. In this case, a pressure applied to the common flow path R2 becomes a negative pressure Pout lower than the atmospheric pressure. In this manner, for example, the pump 63 functions as a pressurizing mechanism that pressurizes the pressure applied to the common flow path R1, and the pump 64 functions as a depressurizing mechanism that depressurizes the pressure applied to the common flow path R2.

Hereinafter, an increase in the positive pressure Pin means, for example, an increase in the pressure that causes the ink stored in the common flow path R1 to be directed to the nozzle N. In addition, an increase in the negative pressure Pout means an increase in the pressure for ejecting the ink stored in the common flow path R2 from the coupling port H2, that is, an increase in reduction amount of the pressure applied to the common flow path R2. Hereinafter, unless otherwise specified, the increase in the negative pressure Pout means an increase in an absolute value of the negative pressure Pout, and a decrease in the negative pressure Pout means a decrease in the absolute value of the negative pressure Pout.

Here, for example, when the negative pressure Pout is lower than an appropriate pressure with respect to the positive pressure Pin, there is a concern that the ink may leak from the nozzle N, and when the negative pressure Pout is larger than the appropriate pressure with respect to the positive pressure Pin, there is a concern that the ink may not be appropriately ejected from the nozzle N. Therefore, the positive pressure Pin and the negative pressure Pout are adjusted such that an ink ejection state becomes a normal state.

In addition, the pressure chamber CV1 is filled with a part of the ink supplied to the common flow path R1, via the coupling flow path BK1. When the piezoelectric element PZ1 is driven by the drive signal COM, a part of the ink filled in the pressure chamber CV1 is ejected from the nozzle N via the coupling flow path BR1. In addition, the part of the ink supplied to the pressure chamber CV1 is filled in the pressure chamber CV2 via the coupling flow path BR1, the nozzle flow path BN, and the coupling flow path BR2. When the piezoelectric element PZ2 is driven by the drive signal COM, the part of the ink filled in the pressure chamber CV2 is ejected from the nozzle N via the coupling flow path BR2. As illustrated in FIG. 4, in the present embodiment, one ejecting portion D includes two piezoelectric elements PZ, two pressure chambers CV, and one nozzle N.

As illustrated in FIGS. 3 and 4, the flow path forming substrate 16 is provided with a through-hole 16h. The through-hole 16h is a hole that is located between the common flow path BC1 and the common flow path BC2 when the flow path forming substrate 16 is viewed in the Z1 direction, and penetrates from a surface of the flow path forming substrate 16 in the Z1 direction to the surface of the flow path forming substrate 16 in the Z2 direction. The wiring substrate 17 is inserted into the through-hole 16h.

As illustrated in FIGS. 3 and 4, the wiring substrate 17 is mounted on a surface of the diaphragm 14 in the Z2 direction. The wiring substrate 17 is a component for electrically coupling the liquid ejecting head 1 to the control unit 4. As the wiring substrate 17, for example, a flexible wiring substrate such as a flexible printed circuit (FPC) or a flexible flat cable (FFC) is preferably adopted. As described above, the electronic component EC including the switching circuit 18, the detection circuit 19, and the like is mounted at the wiring substrate 17.

As illustrated in FIGS. 3 and 4, the compliance sheet CS1 is provided at a position, which is a position in the Z1 direction with respect to the communication plate 12 and in the X1 direction with respect to the nozzle substrate 11, to block the common flow path BA1 and the common flow path BB1. In addition, the compliance sheet CS2 is provided at a position, which is a position in the X2 direction with respect to the nozzle substrate 11 and in the Z1 direction with respect to the communication plate 12, to block the common flow path BA2 and the common flow path BB2. In the following, the compliance sheets CS1 and CS2 may be collectively referred to as a compliance sheet CS. The compliance sheet CS is a plate-shaped member elongated in the Y-axis direction and extending substantially parallel to the XY plane. The compliance sheet CS is formed of an elastic material, and absorbs the pressure fluctuation of the ink in the common flow path BA and the coupling flow path BK.

Although not illustrated, the liquid ejecting head 1 has a cap for sealing the nozzle surface NP, which is a surface of the nozzle substrate 11 in the Z1 direction. The cap seals the nozzle surface NP of the nozzle substrate 11 at which the nozzle N is formed, in a period in which the ink is not ejected from the nozzle N.

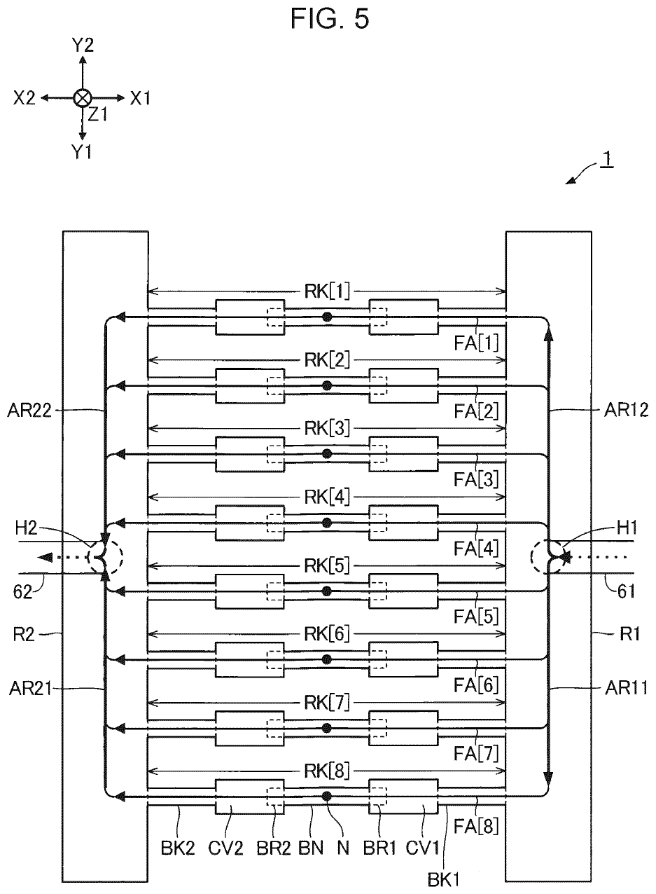

Next, a flow of inks will be described with reference to FIG. 5.

FIG. 5 is an explanatory diagram describing the flow of the ink. FIG. 5 illustrates the flow of the ink in the common flow path R and the individual flow path RK when the liquid ejecting head 1 is viewed in plan view in the Z1 direction. Meanwhile, in FIG. 5, for convenience of illustration, the coupling flow path BK is described as extending in the X-axis direction. Meanwhile, the coupling flow path BK in the liquid ejecting head 1 extends in the Z-axis direction. In addition, in FIG. 5, for convenience of illustration, the supply flow path 61 and the collection flow path 62 are described as extending in the X-axis direction. Meanwhile, the supply flow path 61 and the collection flow path 62 are not limited to extending in the X-axis direction. In addition, in FIG. 5, as an example, it is assumed that the value M is “8”. In addition, in FIG. 5, a case is assumed in which each of the coupling port H1 and the coupling port H2 is located between the individual flow path RK[4] and the individual flow path RK[5] in the Y-axis direction.

When the ink is circulated, the supply flow path 61 supplies an ink to the common flow path R1, and the collection flow path 62 collects the ink from the common flow path R2. For example, in the common flow path R1, the ink flows from the coupling port H1 in the Y1 direction and the Y2 direction as illustrated by arrows AR11 and AR12. An ink flowing from the coupling port H1 in the Y1 direction is supplied to the individual flow paths RK[5] to RK[8], and an ink flowing from the coupling port H1 in the Y2 direction is supplied to the individual flow paths RK[1] to RK[4].

Further, in the individual flow path RK[m], the ink flows from the common flow path R1 to the common flow path R2 in the X2 direction as indicated by an arrow FA[m]. Therefore, for example, the pressure chambers CV1 and CV2 provided in the individual flow path RK[m] are filled with the inks.

In addition, for example, in the common flow path R2, as illustrated by arrows AR21 and AR22, an ink flows from the individual flow path RK[5] to RK[8] in the Y2 direction, and an ink flows from the individual flow path RK[1] to RK[4] in the Y1 direction. That is, the ink discharged from the individual flow paths RK[1] to RK[4] flows in the Y2 direction and is collected in the collection flow path 62 via the coupling port H2. In addition, the ink discharged from the individual flow paths RK[5] to RK[8] flows in the Y1 direction and is collected in the collection flow path 62 via the coupling port H2.

In this manner, the common flow path R1 communicates in common with a plurality of individual flow paths RK, and supplies the ink to the plurality of individual flow paths RK. The common flow path R2 communicates in common with the plurality of individual flow paths RK, and discharges the ink from the plurality of individual flow paths RK. In the present embodiment, a case is assumed in which the ink is circulated as illustrated in FIG. 5 in a recovery process of recovering an ejection state of the nozzle N to a normal state and a printing process of forming an image indicated by the print data IMG on a medium.

Next, an outline of the liquid ejecting head 1 will be described with reference to FIG. 6.

FIG. 6 is a block diagram illustrating an example of a configuration of the liquid ejecting head 1. In FIG. 6, one ejecting portion D[m] among the M ejecting portions D is illustrated in order to make the drawing easy to see.

As described in FIG. 1, the liquid ejecting head 1 includes the recording head 10, the switching circuit 18, and the detection circuit 19. In addition, the liquid ejecting head 1 includes a wiring La to which the drive signal COMa is supplied from the drive signal generation unit 2, a wiring Lb to which the drive signal COMb is supplied from the drive signal generation unit 2, and a wiring Lc to which the drive signal COMc is supplied from the drive signal generation unit 2. Further, the liquid ejecting head 1 includes a wiring Ls that supplies the detection signal Vout to the detection circuit 19, wirings Li1[m] and Li2[m] that supply the individual drive signals Vin1[m] and Vin2[m] to the ejecting portion D[m], respectively, and a wiring Ld to which the bias potential VBS is supplied. Detection signals Vout1 and Vout2 are collectively referred to as the detection signal Vout. Further, in the following, the individual drive signals Vin1 and Vin2 may be collectively referred to as the individual drive signal Vin, and the wirings Li1 and Li2 may be collectively referred to as a wiring Li.

The switching circuit 18 includes M switches SWa1 corresponding to the M ejecting portions D on a one-to-one basis, M switches SWb1 corresponding to the M ejecting portions D on a one-to-one basis, M switches SWc1 corresponding to the M ejecting portions D on a one-to-one basis, and M switches SWs1 corresponding to the M ejecting portions D on a one-to-one basis. Further, the switching circuit 18 includes M switches SWa2 corresponding to the M ejecting portions D on a one-to-one basis, M switches SWb2 corresponding to the M ejecting portions D on a one-to-one basis, M switches SWc2 corresponding to the M ejecting portions D on a one-to-one basis, and M switches SWs2 corresponding to the M ejecting portions D on a one-to-one basis. Hereinafter, the switches SWa1 and SWa2 may be collectively referred to as a switch SWa, the switches SWb1 and SWb2 may be collectively referred to as a switch SWb, the switches SWc1 and SWc2 may be collectively referred to as a switch SWc, and the switches SWs1 and SWs2 may be collectively referred to as a switch SWs.

Further, the switching circuit 18 includes a coupling state designation circuit CSC. The coupling state designation circuit CSC designates a coupling state of each of the M switches SWa1, the M switches SWb1, the M switches SWc1, the M switches SWs1, the M switches SWa2, the M switches SWb2, the M switches SWc2, and the M switches SWs2. For example, the coupling state designation circuit CSC generates coupling state designation signals Qa1[m], Qb1[m], Qc1[m], Qs1[m], Qa2[m], Qb2[m], Qc2[m], and Qs2[m], based on at least some of the print signal SI, a latch signal LAT, a change signal CH, and a period designation signal Tsig supplied from the control unit 4.

For example, the coupling state designation signal Qa1[m] is a signal for designating ON or OFF of the switch SWa1 [m], and the coupling state designation signal Qb1[m] is a signal for designating ON or OFF of the switch SWb1[m]. The coupling state designation signal Qc1[m] is a signal for designating ON or OFF of the switch SWc1[m], and the coupling state designation signal Qs1[m] is a signal for designating ON or OFF of the switch SWs1[m]. The coupling state designation signal Qa2[m] is a signal for designating ON or OFF of the switch SWa2[m], and the coupling state designation signal Qb2[m] is a signal for designating ON or OFF of the switch SWb2[m]. Further, the coupling state designation signal Qc2[m] is a signal for designating ON or OFF of the switch SWc2[m], and the coupling state designation signal Qs2[m] is a signal for designating ON or OFF of the switch SWs2[m].

The switch SWa1[m] switches conduction and non-conduction between the wiring La and an individual electrode Zu1[m] of a piezoelectric element PZ1[m] provided in the ejecting portion D[m], based on the coupling state designation signal Qa1[m]. That is, the switch SWa1[m] switches conduction and non-conduction between the wiring La and the wiring Li1[m] coupled to the individual electrode Zu1[m], based on the coupling state designation signal Qa1[m]. In the present embodiment, the switch SWa1[m] is turned on when the coupling state designation signal Qa1[m] is at a high level, and is turned off when the coupling state designation signal Qa1[m] is at a low level. When the switch SWa1[m] is turned on, the drive signal COMa supplied to the wiring La is supplied to the individual electrode Zu1[m] of the ejecting portion D[m] as the individual drive signal Vin1[m] via the wiring Li1[m].

The switch SWb1[m] switches conduction and non-conduction between the wiring Lb and the individual electrode Zu1[m] of the piezoelectric element PZ1[m] provided in the ejecting portion D[m], based on the coupling state designation signal Qb1[m]. That is, the switch SWb1[m] switches conduction and non-conduction between the wiring Lb and the wiring Li1[m] coupled to the individual electrode Zu1[m], based on the coupling state designation signal Qb1[m]. In the present embodiment, the switch SWb1[m] is turned on when the coupling state designation signal Qb1[m] is at a high level, and is turned off when the coupling state designation signal Qb1[m] is at a low level. When the switch SWb1[m] is turned on, the drive signal COMb supplied to the wiring Lb is supplied to the individual electrode Zu1[m] of the ejecting portion D[m] as the individual drive signal Vin1[m] via the wiring Li1[m].

The switch SWc1[m] switches conduction and non-conduction between the wiring Lc and the individual electrode Zu1[m] of the piezoelectric element PZ1[m] provided in the ejecting portion D[m] based on the coupling state designation signal Qc1[m]. That is, the switch SWc1[m] switches conduction and non-conduction between the wiring Lc and the wiring Li1[m] coupled to the individual electrode Zu1[m], based on the coupling state designation signal Qc1[m]. In the present embodiment, the switch SWc1[m] is turned on when the coupling state designation signal Qc1[m] is at a high level, and is turned off when the coupling state designation signal Qc1[m] is at a low level. When the switch SWc1[m] is turned on, the drive signal COMc supplied to the wiring Lc is supplied to the individual electrode Zu1[m] of the ejecting portion D[m] as the individual drive signal Vin1[m] via the wiring Li1[m].

The switch SWs1[m] switches conduction and non-conduction between the wiring Ls and the individual electrode Zu1[m] of the piezoelectric element PZ1[m] provided in the ejecting portion D[m], based on the coupling state designation signal Qs1[m]. That is, the switch SWs1[m] switches conduction and non-conduction between the wiring Ls and the wiring Li1[m] coupled to the individual electrode Zu1[m], based on the coupling state designation signal Qs1[m]. In the present embodiment, the switch SWs1[m] is turned on when the coupling state designation signal Qs1[m] is at a high level, and is turned off when the coupling state designation signal Qs1[m] is at a low level.

For example, the coupling state designation signal Qs1[m] becomes a high level when residual vibration of the pressure chamber CV1[m] of the ejecting portion D[m] is detected. In the following, the pressure chamber CV in which the residual vibration is detected may be referred to as the pressure chamber CV as a detection target. The switch SWs1[m] is turned on, and the detection signal Vout1[m] indicating a potential of the individual electrode Zu1[m] of the piezoelectric element PZ1[m] corresponding to the pressure chamber CV1[m] as a detection target is supplied to the detection circuit 19 via the wiring Li1[m] and the wiring Ls. The detection circuit 19 generates the residual vibration signal Vd[m] based on the detection signal Vout[m]. In the following, the ejecting portion D including the pressure chamber CV as a detection target may be referred to as the ejecting portion D as a detection target.

As described above, the individual drive signal Vin[m] is a signal supplied to the piezoelectric element PZ[m] of the ejecting portion D[m] via the switch SWa[m], SWb[m], or SWc, among the drive signals COMa, COMb, and COMc. Further, a piezoelectric element PZ2[m] is also driven in the same manner as the piezoelectric element PZ1[m].

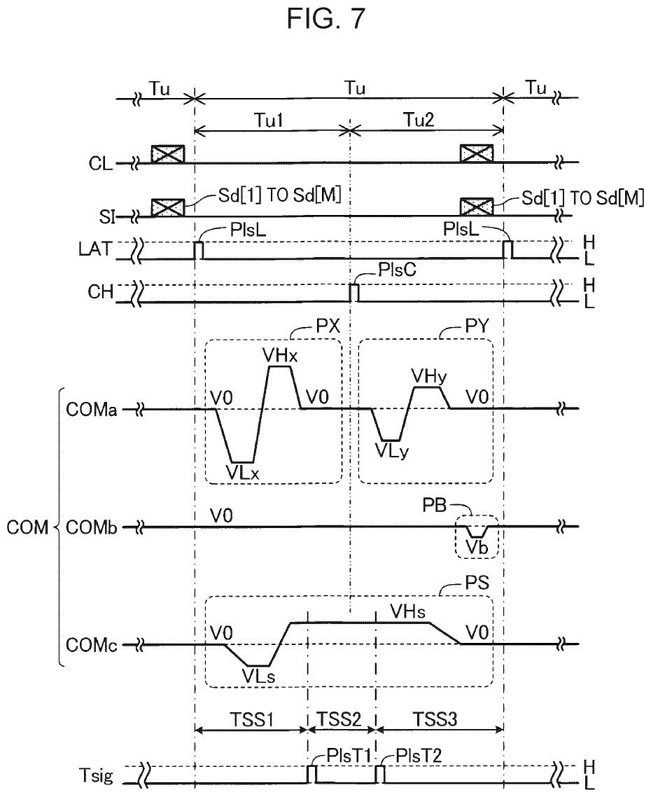

Next, an operation of the liquid ejecting apparatus 100 in a unit period Tu will be described with reference to FIG. 7.

FIG. 7 is a timing chart illustrating an example of the operation of the liquid ejecting apparatus 100 in the unit period Tu. In the present embodiment, when the liquid ejecting apparatus 100 executes a printing process, a printing process period including one or a plurality of unit periods Tu is set as an operation period of the liquid ejecting apparatus 100. The liquid ejecting apparatus 100 according to the present embodiment can drive each ejecting portion D for the printing process in each unit period Tu. Further, the liquid ejecting apparatus 100 according to the present embodiment can drive the ejecting portion D as a detection target and detect the detection signal Vout[m] from the ejecting portion D as a detection target in each unit period Tu.

The control unit 4 outputs the latch signal LAT having a pulse PlsL and the change signal CH having a pulse PlsC. Therefore, the control unit 4 defines the unit period Tu as a period from rising of the pulse PlsL to rising of the next pulse PlsL. The control unit 4 divides the unit period Tu into two control periods Tu1 and Tu2 with the pulse PlsC.

The print signal SI includes, for example, M individual designation signals Sd[1] to Sd[M] corresponding to the M ejecting portions D[1] to D[M] on a one-to-one basis. The individual designation signal Sd[m] designates a mode of the driving of the ejecting portion D[m] in each unit period Tu when the liquid ejecting apparatus 100 executes the printing process.

The control unit 4 supplies the print signal SI including the individual designation signals Sd[1] to Sd[M] to the coupling state designation circuit CSC in synchronization with a clock signal CL before each unit period Tu in which the printing process is executed. Then, the coupling state designation circuit CSC generates the coupling state designation signals Qa1[m], Qb1[m], Qs1[m], Qa2[m], Qb2[m], and Qs2[m], based on the individual designation signal Sd[m] in the unit period Tu.

In the present embodiment, a case is assumed in which the ejecting portion D[m] can form any one of a large dot, a medium dot smaller than the large dot, and a small dot smaller than the medium dot in the unit period Tu. Hereinafter, the amount of ink corresponding to a large dot may be referred to as a large amount of ink, the amount of ink corresponding to a medium dot may be referred to as a medium amount of ink, and the amount of ink corresponding to a small dot may be referred to as a small amount of ink.

For example, the individual designation signal Sd[m] is a signal for designating any one driving mode among five driving modes such as ejection of a large amount of ink, ejection of a medium amount of ink, ejection of a small amount of ink, non-ejection of inks, and driving as the ejecting portion D as a detection target in each unit period Tu for the ejecting portion D[m].

First, an operation of the coupling state designation circuit CSC when a driving mode of the ejecting portion D, which is a detection target, other than the ejecting portion D is designated by the individual designation signal Sd[m] will be described. In the present embodiment, a case is assumed in which the piezoelectric elements PZ1[m] and PZ2[m] of the ejecting portion D[m] are driven in the same manner in ejecting a large amount of ink, ejecting a medium amount of ink, ejecting a small amount of ink, and non-ejecting the ink.

The drive signal generation unit 2 outputs the drive signal COMa having a pulse PX and a pulse PY A waveform of the drive signal COMa in the control period Tu1 corresponds to the pulse PX, and a waveform of the drive signal COMa in the control period Tu2 corresponds to the pulse PY.

In the present embodiment, the pulse PX and the pulse PY are defined such that a potential difference between the highest potential VHx and the lowest potential VLx of the pulse PX is more than a potential difference between the highest potential VHy and the lowest potential VLy of the pulse PY Specifically, when the ejecting portion D[m] is driven by the drive signal COMa having the pulse PX, a waveform of the pulse PX is defined such that a medium amount of ink is ejected from the ejecting portion D[m]. When the ejecting portion D[m] is driven by the drive signal COMa having the pulse PY, a waveform of the pulse PY is defined such that a small amount of ink is ejected from the ejecting portion D[m]. The potentials at a start and an end of the pulse PX and the pulse PY are set to a reference potential VO.

The drive signal generation unit 2 outputs the drive signal COMb having a pulse PB. The pulse PB is a minute vibration waveform such that an ink is not ejected from the ejecting portion D[m] when the individual drive signal Vin[m] having the pulse PB is supplied to the ejecting portion D[m]. That is, the pulse PB is a minute vibration waveform for applying minute vibration to the ink inside the ejecting portion D to prevent the ink from being thickened. For example, in the present embodiment, the pulse PB is determined such that a potential difference between a lowest potential Vb of the pulse PB and the reference potential VO which is a highest potential is lower than a potential difference between the highest potential VHy and the lowest potential VLy of the pulse PY of the drive signal COMa. The potentials at a start and an end of the pulse PB are set to the reference potential Vo.

When the individual designation signal Sd[m] designates the ejecting portion D[m] to form a large dot, the coupling state designation circuit CSC sets the coupling state designation signal Qa[m] to a high level in the control periods Tu1 and Tu2. Further, the coupling state designation circuit CSC sets the coupling state designation signals Qb[m], Qc[m], and Qs[m] to a low level in the unit period Tu. In this case, the ejecting portion D[m] is driven by the pulse PX of the drive signal COMa in the control period Tu1 to eject a medium amount of ink, and is driven by the pulse PY of the drive signal COMa in the control period Tu2 to eject a small amount of ink. Therefore, the ejecting portion D[m] ejects a large amount of ink in total in the unit period Tu, and thus a large dot is formed at the medium PP.

Further, when the individual designation signal Sd[m] designates the ejecting portion D[m] to form a medium dot, the coupling state designation circuit CSC sets the coupling state designation signal Qa[m] to a high level in the control period Tu1 and to a low level in the control period Tu2, respectively. In addition, the coupling state designation circuit CSC sets the coupling state designation signal Qb[m] to a low level in the control period Tu1 and to a high level in the control period Tu2, respectively, and sets the coupling state designation signals Qc[m] and Qs[m] to a low level in the unit period Tu. The coupling state designation signals Qb[m], Qc[m], and Qs[m] are set to a low level in the unit period Tu. In this case, the ejecting portion D[m] is driven by the pulse PX of the drive signal COMa in the control period Tu1 to eject a medium amount of ink, and is driven by the pulse PB of the drive signal COMb in the control period Tu2 not to eject the ink. Therefore, the ejecting portion D[m] ejects a medium amount of ink in the unit period Tu, and a medium dot is formed at the medium PP.

Further, when the individual designation signal Sd[m] designates the ejecting portion D[m] to form a small dot, the coupling state designation circuit CSC sets the coupling state designation signal Qa[m] to a low level in the control period Tu1 and to a high level in the control period Tu2, respectively. In addition, the coupling state designation circuit CSC sets the coupling state designation signal Qb[m] to a high level in the control period Tu1 and to a low level in the control period Tu2, respectively, and sets the coupling state designation signals Qc[m] and Qs[m] to a low level in the unit period Tu. In this case, in the control period Tu1, the reference potential VO is supplied to the piezoelectric element PZ[m] of the ejecting portion D[m] by the drive signal COMb. In this manner, in the control period Tu1, the reference potential VO is supplied to the ejecting portion D[m] by the drive signal COMb such that a shape of the piezoelectric element PZ[m] of the ejecting portion D[m] is not deformed. Further, in the control period Tu2, the ejecting portion D[m] is driven by the pulse PY of the drive signal COMa to eject a small amount of ink. Therefore, the ejecting portion D[m] ejects a small amount of ink in the unit period Tu, and a small dot is formed at the medium PP.

Further, when the individual designation signal Sd[m] designates the ejecting portion D[m] not to eject the ink, the coupling state designation circuit CSC sets the coupling state designation signal Qb[m] to a high level in the unit period Tu, and sets the coupling state designation signals Qa[m], Qc[m], and Qs[m] to a low level in the unit period Tu. In this case, the ejecting portion D[m] is driven not to eject the ink by the pulse PB of the drive signal COMb in the unit period Tu. Therefore, the ejecting portion D[m] does not eject the ink, and does not form a dot on the medium PP, in the unit period Tu. Further, since the ejecting portion D[m] is driven to such an extent that the ink is not ejected, thickening of the ink in the ejecting portion D[m] is prevented.

Next, an operation of the coupling state designation circuit CSC or the like when a driving mode of the ejecting portion D as a detection target is designated by the individual designation signal Sd[m] will be described.

For example, the drive signal generation unit 2 outputs the drive signal COMc having a pulse PS. A waveform of the drive signal COMc in the unit period Tu corresponds to the pulse PS. In the present embodiment, the pulse PS is defined such that a potential difference between the highest potential VHs and the lowest potential VLs of the pulse PS is less than a potential difference between the highest potential VHy and the lowest potential VLy of the pulse PY Specifically, when the drive signal COMc having the pulse PS is supplied to the ejecting portion D[m], a waveform of the pulse PS is defined to drive the ejecting portion D[m] to the extent that an ink is not ejected from the ejecting portion D[m]. The potentials at a start and an end of the pulse PS are set to the reference potential VO.

The control unit 4 outputs the period designation signal Tsig having a pulse PlsT1 and a pulse PlsT2. Therefore, the control unit 4 divides the unit period Tu into a control period TSS1 from a start of the pulse PlsL to a start of the pulse PlsT1, a control period TSS2 from a start of the pulse PlsT1 to a start of the pulse PlsT2, and a control period TSS3 from a start of the pulse PlsT2 to a start of the next pulse PlsL.

For example, when the individual designation signal Sd[m] designates the pressure chamber CV1[m] as the pressure chamber CV of a detection target, the coupling state designation circuit CSC sets the coupling state designation signals Qa1[m], Qb1, Qa2[m], Qb2[m], Qc2[m], and Qs2[m] to a low level in the unit period Tu. Further, the coupling state designation circuit CSC sets the coupling state designation signal Qc1[m] to a high level in the control periods TSS1 and TSS3 and to a low level in the control period TSS2, respectively. Further, the coupling state designation circuit CSC sets the coupling state designation signal Qs1[m] to a low level in the control periods TSS1 and TSS3 and to a high level in the control period TSS2, respectively.

In this case, the piezoelectric element PZ1[m] corresponding to the pressure chamber CV1[m] as a detection target is driven by the pulse PS of the drive signal COMc in the control period TSS1. Specifically, the piezoelectric element PZ1[m] is displaced by the pulse PS of the drive signal COMc in the control period TSS1. As a result, vibration is generated in the pressure chamber CV1[m] as a detection target. The vibration generated in the control period TSS1 remains in the control period TSS2. In the control period TSS2, a potential of the individual electrode Zu1[m] of the piezoelectric element PZ1[m] corresponding to the pressure chamber CV1[m] as a detection target is changed according to the residual vibration generated in the pressure chamber CV1[m]. That is, in the control period TSS2, a potential of the individual electrode Zu of the piezoelectric element PZ corresponding to the pressure chamber CV as a detection target becomes a potential according to an electromotive force of the piezoelectric element PZ caused by the residual vibration generated in the pressure chamber CV as a detection target. The potential of the individual electrode Zu is detected as the detection signal Vout in the control period TSS2.

In the above example, a case is assumed in which only the piezoelectric element PZ1[m] among the piezoelectric elements PZ1[m] and PZ2[m] included in the pressure chamber CV1[m] as a detection target is driven. Meanwhile, both the piezoelectric elements PZ1[m] and PZ2[m] may be driven. That is, both the piezoelectric elements PZ1[m] and PZ2[m] included in the pressure chamber CV1[m] as a detection target may be driven by the pulse PS of the drive signal COMc in the control period TSS1.

The operation of the liquid ejecting apparatus 100 is not limited to the example illustrated in FIG. 7. For example, in FIG. 7, a case where a size of the dot that can be formed at the medium PP is limited to three types of large, medium, and small is illustrated. Meanwhile, the size of the dot that can be formed at the medium PP is not limited to three types. Specifically, the size of the dot that can be formed at the medium PP may be one type or two types. The drive signal COMc may have a minute vibration waveform, for example, the pulse PB as the pulse PS in the control period TSS1 for applying minute vibration to the ink inside the ejecting portion D to prevent the ink from being thickened. In this case, the drive signal generation unit 2 may not generate the drive signal COMb.

In addition, in FIG. 7, a case where the detection signal Vout for detecting the presence or absence of an abnormality in an ejection state of the nozzle N of the ejecting portion D as a detection target is generated during the printing process period is illustrated. Meanwhile, the detection signal Vout may be generated during a period different from the printing process period. That is, a process of detecting the presence or absence of the abnormality in the ejection state of the nozzle N of the ejecting portion D as a detection target may be executed in a period different from the printing process period. The pulse PB may be used when the ink is circulated without being ejected from the nozzle N. For example, when printing is performed for each pass while moving the liquid ejecting head 1 along the X-axis, the pressure chamber CV may be vibrated by the pulse PB between the passes to circulate the ink. In addition, the pressure chamber CV may be vibrated by the pulse PB to circulate the ink between a print job based on one print data IMG and a print job based on the other print data IMG. Alternatively, the ink may be circulated by causing the pressure chamber CV to vibrate by the pulse PB during maintenance.

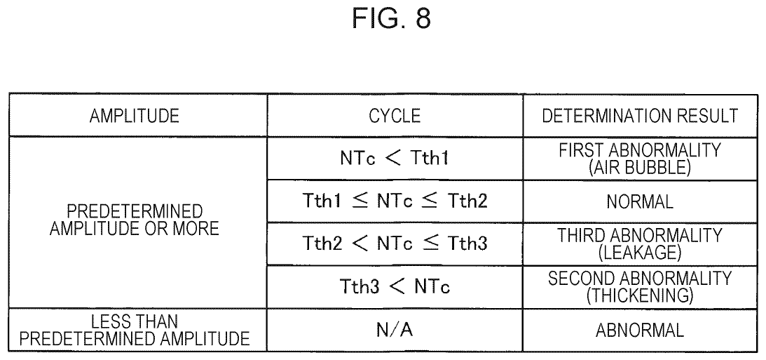

Next, an operation of the determination unit 3 will be described with reference to FIG. 8.

FIG. 8 is an explanatory diagram describing an operation of the determination unit 3.

In general, residual vibration generated in the pressure chamber CV has a natural vibration frequency determined by a shape of the nozzle N, a weight of an ink with which the pressure chamber CV is filled, a viscosity of the ink with which the pressure chamber CV is filled, and the like.

In addition, in general, when an abnormality occurs in an ejection state of the nozzle N since air bubbles are mixed in the nozzle N, a frequency of the residual vibration becomes higher as compared with a case where the air bubbles are not mixed in the nozzle N. In general, when a foreign matter such as paper dust adheres to the vicinity of the nozzle N of the ejecting portion D and thus an abnormality occurs in the ejection state of the nozzle N, the frequency of the residual vibration becomes lower as compared with a case where the foreign matter does not adhere. For example, when the ink is leaked from the nozzle N and thus an abnormality occurs in the ejection state of the nozzle N, the frequency of the residual vibration becomes lower as compared with a case where the ink is not leaked from the nozzle N. In general, when the ink in the nozzle N is thickened and an abnormality occurs in the ejection state of the nozzle N, the frequency of the residual vibration becomes lower as compared with a case where the ink in the nozzle N is not thickened. In general, when the ink in the nozzle N is thickened and an abnormality occurs in the ejection state of the nozzle N, the frequency of the residual vibration becomes lower as compared with a case where a foreign matter such as paper dust adheres to the vicinity of the nozzle N. In addition, in general, when the pressure chamber CV of the ejecting portion D is not filled with the ink and thus an abnormality occurs in the ejection state of the nozzle N, or when the piezoelectric element PZ is failed and cannot be displaced, and thus an abnormality occurs in the ejection state of the nozzle N, an amplitude of the residual vibration is reduced.

As described above, the residual vibration signal Vd indicates a waveform corresponding to the residual vibration generated in the pressure chamber CV, which is a detection target. Specifically, the residual vibration signal Vd indicates a frequency corresponding to a frequency of the residual vibration generated in the pressure chamber CV as a detection target, and indicates an amplitude corresponding to an amplitude of the residual vibration generated in the pressure chamber CV as a detection target. Therefore, the determination unit 3 can determine the ink ejection state of the nozzle N of the ejecting portion D as a detection target, based on the residual vibration signal Vd.

In the determination on the ejection state, the determination unit 3 measures a time length of one cycle of the residual vibration signal Vd, as a cycle NTc of the residual vibration signal Vd. In addition, the determination unit 3 determines whether or not the residual vibration signal Vd has a predetermined amplitude in the determination on the ejection state. Specifically, the determination unit 3 determines whether or not a potential of the residual vibration signal Vd is equal to or higher than a first threshold potential, which is a potential higher than a potential of an amplitude center level of the residual vibration signal Vd, and is equal to or lower than a second threshold potential, which is a potential lower than the potential of the amplitude center level, in a period in which the cycle NTc of the residual vibration signal Vd is measured. Then, when a result of the determination is affirmative, it is specified that the residual vibration signal Vd has a predetermined amplitude, and when the result of the determination is negative, it is specified that the residual vibration signal Vd does not have the predetermined amplitude. Then, the determination unit 3 generates the determination result information Rinf indicating the determination result of the ejection state of the nozzle N of the ejecting portion D as a detection target, based on the cycle NTc and the amplitude of the residual vibration signal Vd.

For example, when the amplitude of the residual vibration signal Vd is equal to or higher than a predetermined amplitude, the determination unit 3 determines the ejection state of the nozzle N of the ejecting portion D as a detection target by comparing the cycle NTc of the residual vibration signal Vd with some or all of threshold values Tth1, Tth2, and Tth3.

Here, the threshold value Tth1 is a value for indicating a boundary between a time length of one cycle of residual vibration when the ejection state of the nozzle N is normal and a time length of one cycle of the residual vibration when air bubbles are mixed in the pressure chamber CV The threshold value Tth2 is a value for indicating a boundary between the time length of one cycle of the residual vibration when the ejection state of the nozzle N is normal and a time length of one cycle of the residual vibration when the foreign matter adheres to the vicinity of the nozzle N. The threshold value Tth3 is a value for indicating a boundary between the time length of one cycle of the residual vibration when the foreign matter adheres to the vicinity of the nozzle N and a time length of one cycle of the residual vibration when the ink in the pressure chamber CV is thickened. The threshold values Tth1, Tth2, and Tth3 satisfy “Tth1<Tth2<Tth3”.

As illustrated in FIG. 8, in the present embodiment, the determination unit 3 determines that the ejection state of the nozzle N of the ejecting portion D as a detection target is normal when the amplitude of the residual vibration signal Vd is equal to or higher than a predetermined amplitude and the cycle NTc of the residual vibration signal Vd satisfies “Tth1≤NTc≤Tth2”.

When the amplitude of the residual vibration signal Vd is equal to or higher than the predetermined amplitude and the cycle NTc of the residual vibration signal Vd satisfies “NTc<Tth1”, the determination unit 3 determines that the ejection state of the nozzle N has a first abnormality caused by mixing of air bubbles into the nozzle N. In addition, when the amplitude of the residual vibration signal Vd is equal to or higher than the predetermined amplitude and the cycle NTc of the residual vibration signal Vd satisfies “Tth2<NTc≤Tth3”, the determination unit 3 determines that the ejection state of the nozzle N has a third abnormality caused by a leakage of the ink from the nozzle N. In addition, when the amplitude of the residual vibration signal Vd is equal to or higher than the predetermined amplitude and the cycle NTc of the residual vibration signal Vd satisfies “Tth3<NTc”, the determination unit 3 determines that the ejection state of the nozzle N has a second abnormality caused by thickening of the ink in the nozzle N.

When the amplitude of the residual vibration signal Vd is less than the predetermined amplitude, the determination unit 3 determines that the ejection state of the nozzle N has an abnormality. In the present embodiment, when the amplitude of the residual vibration signal Vd is less than the predetermined amplitude, the ejection state of the nozzle N has an abnormality other than the first abnormality, the second abnormality, and the third abnormality described above.

Next, with reference to FIG. 9, among recovery processes of recovering an ejection state of the nozzle N to a normal state, a first recovery process executed when the ejection state of the nozzle N has a first abnormality caused by mixing of air bubbles into the nozzle N will be described.

FIG. 9 is a flowchart illustrating an example of a first recovery process. The first recovery process is executed when the ejection state of the nozzle N has the first abnormality caused by the mixing of air bubbles into the nozzle N. That is, a process in step S100 is executed when the determination unit 3 determines that the ejection state of the nozzle N has the first abnormality. The first recovery process illustrated in FIG. 9, that is, a series of processes from step S100 to step S128 is executed by the control unit 4 that functions as the recovery control portion 40. In addition, detailed description of the processes described with reference to FIGS. 1 to 8 will be omitted. As described with reference to FIG. 5, in the present embodiment, a case is assumed in which an ink is circulated in a recovery process such as the first recovery process and a printing process.

First, in step S100, the recovery control portion 40 continues circulation of an ink. For example, the recovery control portion 40 continues the circulation of the ink by controlling the pumps 63 and 64.

In step S102, the recovery control portion 40 waits for a predetermined time, and then shifts the process to step S104.

In step S104, the recovery control portion 40 acquires the determination result information Rinf indicating a determination result of an ejection state of the nozzle N from the determination unit 3. For example, the recovery control portion 40 controls the liquid ejecting head 1 or the like to cause the determination unit 3 to re-determine the ejection state of the nozzle N. The recovery control portion 40 acquires the determination result information Rinf indicating a result of the re-determination from the determination unit 3.

Next, in step S106, the recovery control portion 40 determines whether or not the ejection state of the nozzle N is recovered from a first abnormal state to a normal state, based on the determination result information Rinf. When a result of the determination in step S106 is affirmative, the recovery control portion 40 ends the first recovery process illustrated in FIG. 9. On the other hand, when the result of the determination in step S106 is negative, the recovery control portion 40 shifts the process to step S108.

In step S108, the recovery control portion 40 determines whether or not a series of processes from step S100 to step S106 is executed a predetermined number of times. When a result of the determination in step S108 is affirmative, the recovery control portion 40 shifts the process to step S110. On the other hand, when the result of the determination in step S108 is negative, the recovery control portion 40 returns the process to step S100.

That is, a process in step S110 is executed when the ejection state of the nozzle N is not recovered from the first abnormal state to the normal state even when the circulation of the ink is continued for a time corresponding to a product of the predetermined time and the predetermined number of times. In other words, when a result of the determination on the ejection state of the nozzle N by the determination unit 3 after the circulation of the ink by the circulation mechanism 6 is continued for the time corresponding to the product of the predetermined time and the predetermined number of times indicates that the first abnormality is continued, the process in step S110 is executed. The time corresponding to the product of the predetermined time and the predetermined number of times is an example of a “first time”.

In step S110, the recovery control portion 40 increases a circulation flow rate of the ink. For example, the recovery control portion 40 increases the positive pressure Pin applied to the common flow path R1 and the negative pressure Pout applied to the common flow path R2 by controlling the pumps 63 and 64. Specifically, the recovery control portion 40 controls the pumps 63 and 64 such that, for example, the positive pressure Pin becomes the current positive pressure Pin+10 [Pa] and the negative pressure Pout becomes the current negative pressure Pout −10 [Pa]. The increase amounts of the positive pressure Pin and the negative pressure Pout are not limited to the example described above.

Then, in step S112, the recovery control portion 40 waits for a predetermined time, and then shifts the process to step S114. The predetermined time in step S112 may be the same time as the predetermined time in step S102, or may be a time different from the predetermined time in step S102.

In step S114, the recovery control portion 40 acquires the determination result information Rinf indicating a determination result of the ejection state of the nozzle N from the determination unit 3, in the same manner as step S104.

Next, in step S116, the recovery control portion 40 determines whether or not the ejection state of the nozzle N is recovered from the first abnormal state to the normal state based on the determination result information Rinf. When the result of the determination in step S116 is affirmative, the recovery control portion 40 ends the first recovery process illustrated in FIG. 9. On the other hand, when the result of the determination in step S116 is negative, the recovery control portion 40 shifts the process to step S118.

In step S118, the recovery control portion 40 determines whether or not a series of processes from step S110 to step S116 are executed a predetermined number of times. When a result of the determination in step S118 is affirmative, the recovery control portion 40 shifts the process to step S120. On the other hand, when the result of the determination in step S118 is negative, the recovery control portion 40 returns the process to step S110. That is, when the ejection state of the nozzle N is not recovered to the normal state from the first abnormal state even when the circulation of the ink is continued for a predetermined time by increasing the circulation flow rate of the ink, the process in step S110 is executed again.

The predetermined number of times used for the determination in step S118 may be the same number of times as the predetermined number of times used for the determination in step S108, or may be the number of times different from the predetermined number of times used for the determination in step S108. The predetermined number of times used for the determination in step S118 is an example of a “first number of times”.

In step S120, the recovery control portion 40 increases the positive pressure Pin applied to the common flow path R1 by controlling the pump 63. For example, the recovery control portion 40 controls the pump 63 such that the positive pressure Pin becomes +10 [Pa] from the current positive pressure Pin, and controls the pump 64 such that the negative pressure Pout is maintained at the current negative pressure Pout. The amount of increase in the positive pressure Pin is not limited to the example described above.

In step S122, the recovery control portion 40 waits for a predetermined time, and then shifts the process to step S124. The predetermined time in step S122 may be the same time as the predetermined time in step S102, or may be a time different from the predetermined time in step S102.

In step S124, the recovery control portion 40 acquires the determination result information Rinf indicating a determination result of the ejection state of the nozzle N from the determination unit 3, in the same manner as step S104.

Next, in step S126, the recovery control portion 40 determines whether or not the ejection state of the nozzle N is recovered from the first abnormal state to the normal state based on the determination result information Rinf. When a result of the determination in step S126 is affirmative, the recovery control portion 40 ends the first recovery process illustrated in FIG. 9. On the other hand, when the result of the determination in step S126 is negative, the recovery control portion 40 shifts the process to step S128.

In step S128, the recovery control portion 40 determines whether or not a series of processes from step S120 to step S126 are executed a predetermined number of times. When a result of the determination in step S128 is affirmative, the recovery control portion 40 ends the first recovery process illustrated in FIG. 9, assuming that the ejection state of the nozzle N cannot be recovered to the normal state. On the other hand, when the result of the determination in step S128 is negative, the recovery control portion 40 returns the process to step S120. That is, when the ejection state of the nozzle N is not recovered to the normal state from the first abnormal state even when the positive pressure Pin is increased to continue the circulation of the ink for a predetermined time, the process in step S120 is executed again.

The predetermined number of times used for the determination in step S128 may be the same number of times as the predetermined number of times used for the determination in step S108, or may be the number of times different from the predetermined number of times used for the determination in step S108.

The first recovery process is not limited to the example illustrated in FIG. 9. For example, the recovery control portion 40 may maintain the positive pressure Pin at the current positive pressure Pin, and decrease the negative pressure Pout in step S120. Specifically, in step S120, the recovery control portion 40 may control the pump 63 such that the positive pressure Pin is maintained at the current positive pressure Pin, and may control the pump 64 such that the negative pressure Pout becomes +10 [Pa] from the current negative pressure Pout. That is, in step S120, the recovery control portion 40 increases a ratio of the positive pressure Pin to an absolute value of the negative pressure Pout. Further, the process in step S100 may be regarded as the “first recovery process”.

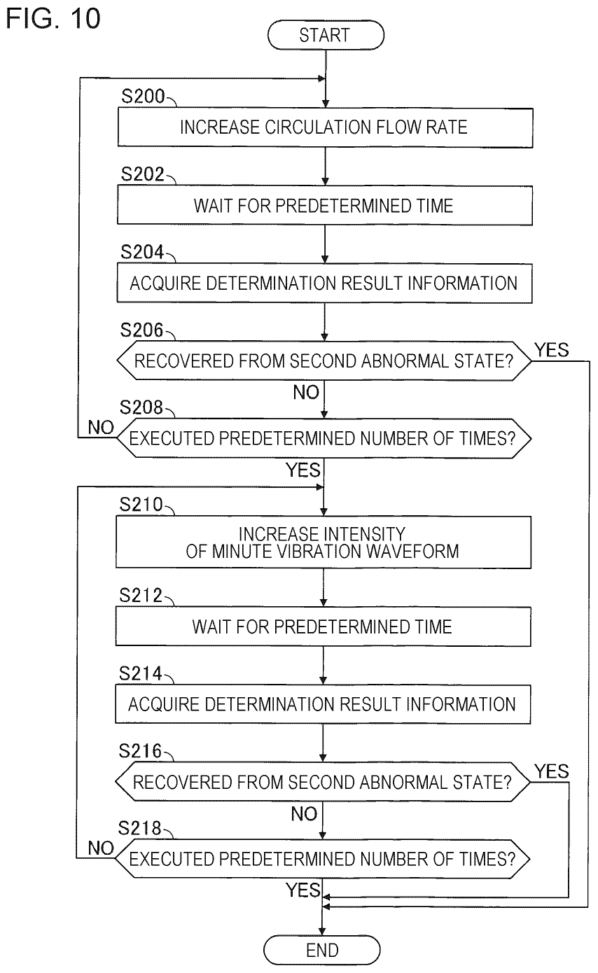

Next, a second recovery process executed when an ejection state of the nozzle N has a second abnormality caused by thickening of inks in the nozzle N will be described with reference to FIG. 10.

FIG. 10 is a flowchart illustrating an example of the second recovery process. The second recovery process is executed when the ejection state of the nozzle N has the second abnormality caused by the thickening of the ink in the nozzle N. That is, a process in step S200 is executed when the determination unit 3 determines that the ejection state of the nozzle N has the second abnormality. The second recovery process illustrated in FIG. 10, that is, a series of processes from step S200 to step S218 is executed by the control unit 4 that functions as the recovery control portion 40. In addition, detailed descriptions of a process having the same manner as the process described with reference to FIG. 9 will be omitted.

First, in step S200, the recovery control portion 40 increases a circulation flow rate of the ink. For example, the recovery control portion 40 increases the positive pressure Pin applied to the common flow path R1 and the negative pressure Pout applied to the common flow path R2 by controlling the pumps 63 and 64. Specifically, the recovery control portion 40 controls the pumps 63 and 64 such that, for example, the positive pressure Pin becomes +20 [Pa] from the current positive pressure Pin and the negative pressure Pout becomes −20 [Pa] from the current negative pressure Pout. The increase amounts of the positive pressure Pin and the negative pressure Pout are not limited to the example described above.

Then, in step S202, the recovery control portion 40 waits for a predetermined time, and then shifts the process to step S204. The predetermined time in step S202 may be the same time as the predetermined time in step S102 illustrated in FIG. 9, or may be a time different from the predetermined time in step S102.

In step S204, the recovery control portion 40 acquires the determination result information Rinf indicating a determination result of the ejection state of the nozzle N from the determination unit 3, in the same manner as step S104 illustrated in FIG. 9.

Next, in step S206, the recovery control portion 40 determines whether or not the ejection state of the nozzle N is recovered from a second abnormal state to a normal state based on the determination result information Rinf. When a result of the determination in step S206 is affirmative, the recovery control portion 40 ends the second recovery process illustrated in FIG. 10. On the other hand, when the result of the determination in step S206 is negative, the recovery control portion 40 shifts the process to step S208.

In step S208, the recovery control portion 40 determines whether or not a series of processes from step S200 to step S206 is executed a predetermined number of times. The predetermined number of times used for the determination in step S208 may be the same number of times as the predetermined number of times used for the determination in step S108 illustrated in FIG. 9, or may be the number of times different from the predetermined number of times used for the determination in step S108.

When a result of the determination in step S208 is negative, the recovery control portion 40 returns the process to step S200. That is, when the ejection state of the nozzle N is not recovered from the second abnormal state to the normal state even when the circulation of the ink is continued for a predetermined time by increasing the circulation flow rate of the ink, the process in step S200 is executed again. In other words, when a result of the determination on the ejection state of the nozzle N by the determination unit 3 after the circulation of the ink is continued for a predetermined time by increasing the circulation flow rate of the ink indicates that the second abnormality is continued, the recovery control portion 40 further increases the circulation flow rate of the ink in step S200. The predetermined time in step S202 is an example of a “second time”.

On the other hand, when the result of the determination in step S208 is affirmative, the recovery control portion 40 shifts the process to step S210. That is, the process in step S210 is executed when the ejection state of the nozzle N is not recovered from the second abnormal state to the normal state even when the control for increasing the circulation flow rate of the ink and continuing the circulation of the ink for the predetermined time is executed a predetermined number of times. In other words, when a result of the determination on the ejection state of the nozzle N by the determination unit 3 after the control of increasing the circulation flow rate of the ink and continuing the circulation of the ink for the predetermined time is executed the predetermined number of times indicates that the second abnormality is continued, the process in step S210 is executed. The predetermined number of times used for the determination in step S208 is an example of a “second number of times”.

In step S210, the recovery control portion 40 increases an intensity of a minute vibration waveform applied to the piezoelectric element PZ from the current intensity. The intensity of the minute vibration waveform is increased, for example, by increasing an amplitude of the minute vibration waveform. In the present embodiment, the pulse PB of the drive signal COMb is applied to the piezoelectric element PZ as the minute vibration waveform. Therefore, the recovery control portion 40 controls, for example, the drive signal generation unit 2 to increase the amplitude of the pulse PB of the drive signal COMb from the current amplitude.

Then, in step S212, the recovery control portion 40 waits for a predetermined time, and then shifts the process to step S214. The predetermined time in step S212 may be the same time as the predetermined time in step S102 illustrated in FIG. 9, or may be a time different from the predetermined time in step S102.

In step S214, the recovery control portion 40 acquires the determination result information Rinf indicating a determination result of the ejection state of the nozzle N from the determination unit 3, in the same manner as step S104 illustrated in FIG. 9.

Next, in step S216, the recovery control portion 40 determines whether or not the ejection state of the nozzle N is recovered from the second abnormal state to the normal state based on the determination result information Rinf. When a result of the determination in step S216 is affirmative, the recovery control portion 40 ends the second recovery process illustrated in FIG. 10. On the other hand, when the result of the determination in step S216 is negative, the recovery control portion 40 shifts the process to step S218.

In step S218, the recovery control portion 40 determines whether or not a series of processes from step S210 to step S216 is executed a predetermined number of times. When a result of the determination in step S218 is affirmative, the recovery control portion 40 ends the second recovery process illustrated in FIG. 10, assuming that the ejection state of the nozzle N cannot be recovered to the normal state. On the other hand, when the result of the determination in step S218 is negative, the recovery control portion 40 returns the process to step S210. That is, when the ejection state of the nozzle N is not recovered from the second abnormal state to the normal state even when the intensity of the minute vibration waveform is increased and the circulation of the ink is continued for the predetermined time, the process in step S210 is executed again.

The predetermined number of times used for the determination in step S218 may be the same number of times as the predetermined number of times used for the determination in step S108 illustrated in FIG. 9, or may be the number of times different from the predetermined number of times used for the determination in step S108.

The second recovery process is not limited to the example illustrated in FIG. 10. For example, a method of increasing the intensity of the minute vibration waveform in step S210 is not limited to increasing the amplitude of the pulse PB. Specifically, the recovery control portion 40 may control the drive signal generation unit 2 or the like such that the number of pulses PB applied to the piezoelectric element PZ in the unit period Tu is increased, instead of increasing the amplitude of the pulse PB, or in addition to increasing the amplitude of the pulse PB. Further, the process in step S200 may be regarded as the “second recovery process”.

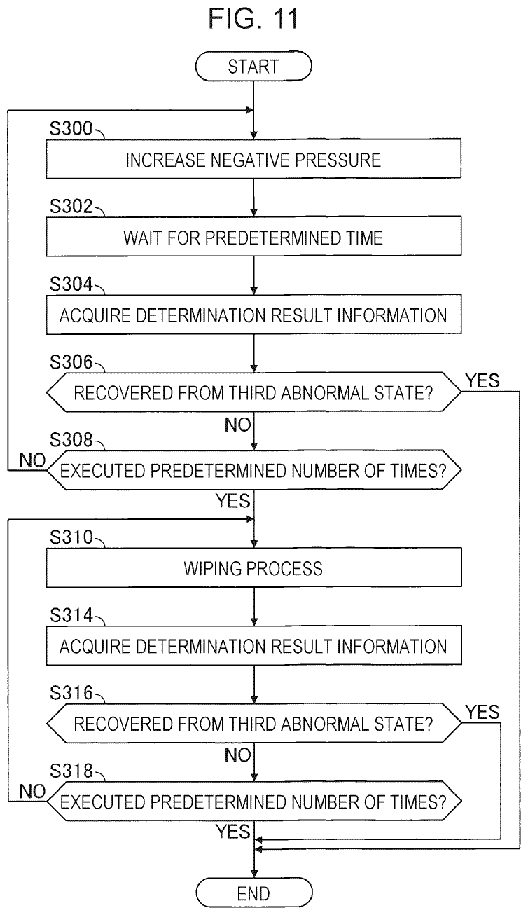

Next, a third recovery process executed when an ejection state of the nozzle N has a third abnormality caused by a leakage of inks from the nozzle N will be described with reference to FIG. 11.

FIG. 11 is a flowchart illustrating an example of the third recovery process. The third recovery process is executed when the ejection state of the nozzle N has the third abnormality caused by the ink leakage from the nozzle N. That is, a process in step S300 is executed when the determination unit 3 determines that the ejection state of the nozzle N has the third abnormality. The third recovery process illustrated in FIG. 11, that is, a series of processes from step S300 to step S318 is executed by the control unit 4 that functions as the recovery control portion 40. In addition, detailed descriptions of a process having the same manner as the process described with reference to FIG. 9 and FIG. 10 will be omitted.

First, in step S300, the recovery control portion 40 increases the negative pressure Pout applied to the common flow path R2 by controlling the pump 64. For example, the recovery control portion 40 controls the pump 63 such that the positive pressure Pin is maintained at the current positive pressure Pin, and controls the pump 64 such that the negative pressure Pout becomes −30 [Pa] from the current negative pressure Pout. The increase amount of the negative pressure Pout is not limited to the example described above.

In step S302, the recovery control portion 40 waits for a predetermined time, and then shifts the process to step S304. The predetermined time in step S302 may be the same time as the predetermined time in step S102 illustrated in FIG. 9, or may be a time different from the predetermined time in step S102.

In step S304, the recovery control portion 40 acquires the determination result information Rinf indicating a determination result of the ejection state of the nozzle N from the determination unit 3, in the same manner as step S104 illustrated in FIG. 9.

Next, in step S306, the recovery control portion 40 determines whether or not the ejection state of the nozzle N is recovered from a third abnormal state to a normal state based on the determination result information Rinf. When a result of the determination in step S306 is affirmative, the recovery control portion 40 ends the third recovery process illustrated in FIG. 11. On the other hand, when the result of the determination in step S306 is negative, the recovery control portion 40 shifts the process to step S308.

In step S308, the recovery control portion 40 determines whether or not a series of processes from step S300 to step S306 is executed a predetermined number of times. The predetermined number of times used for the determination in step S308 may be the same number of times as the predetermined number of times used for the determination in step S108 illustrated in FIG. 9, or may be the number of times different from the predetermined number of times used for the determination in step S108.

When a result of the determination in step S308 is negative, the recovery control portion 40 returns the process to step S300. That is, when the ejection state of the nozzle N is not recovered to the normal state from the third abnormal state even when the negative pressure Pout is increased to continue the circulation of the ink for a predetermined time, the process in step S300 is executed again.

On the other hand, when the result of the determination in step S308 is affirmative, the recovery control portion 40 shifts the process to step S310. That is, the process in step S310 is executed when the ejection state of the nozzle N is not recovered from the third abnormal state to the normal state even when the control for increasing the negative pressure Pout and continuing the circulation of the ink for a predetermined time is executed a predetermined number of times.

In step S310, the recovery control portion 40 controls the maintenance unit 7 to execute a wiping process of wiping off a foreign matter such as an ink adhering to the vicinity of the nozzle N by the wiper.

Then, in step S314, the recovery control portion 40 acquires the determination result information Rinf indicating a determination result of the ejection state of the nozzle N from the determination unit 3, in the same manner as step S104 illustrated in FIG. 9.

Next, in step S316, the recovery control portion 40 determines whether or not the ejection state of the nozzle N is recovered from the third abnormal state to the normal state based on the determination result information Rinf. When a result of the determination in step S316 is affirmative, the recovery control portion 40 ends the third recovery process illustrated in FIG. 10. On the other hand, when the result of the determination in step S316 is negative, the recovery control portion 40 shifts the process to step S318.

In step S318, the recovery control portion 40 determines whether or not a series of processes from step S310 to step S316 are executed a predetermined number of times. When a result of the determination in step S318 is affirmative, the recovery control portion 40 ends the third recovery process illustrated in FIG. 11, assuming that the nozzle N cannot be recovered to the normal ejection state. On the other hand, when the result of the determination in step S318 is negative, the recovery control portion 40 returns the process to step S310, and executes the wiping process again. The predetermined number of times used for the determination in step S318 may be the same number of times as the predetermined number of times used for the determination in step S108 illustrated in FIG. 9, or may be the number of times different from the predetermined number of times used for the determination in step S108.

The third recovery process is not limited to the example illustrated in FIG. 11. For example, the recovery control portion 40 may maintain the negative pressure Pout at the current negative pressure Pout, and decrease the positive pressure Pin in step S300. Specifically, the recovery control portion 40 may control the pump 63 such that the positive pressure Pin becomes −30 [Pa] from the current positive pressure Pin, and may control the pump 64 such that the negative pressure Pout is maintained at the current negative pressure Pout. That is, the recovery control portion 40 increases a ratio of an absolute value of the negative pressure Pout to the positive pressure Pin in step S300. Further, the process in step S300 may be regarded as the “third recovery process”.

In this manner, in the present embodiment, the recovery control portion 40 executes different processes according to a type of an abnormality of an ejection state of the nozzle N as a recovery process of recovering the ejection state of the nozzle N to a normal state by controlling the circulation mechanism 6. That is, in the present embodiment, the ejection state of the nozzle N can be recovered to the normal state by appropriately adjusting circulation of inks in accordance with the type of the abnormality in the ejection state of the nozzle N.

For example, when a first abnormality occurs due to mixing of air bubbles from an interface of the nozzle N into the nozzle N, the air bubbles are moved to the common flow path R2 even when the circulation flow rate at that time is continued by the process in step S100 as illustrated in FIG. 9. On the other hand, when a second abnormality occurs due to thickening of the ink in the nozzle N as the ink evaporates at the interface of the nozzle N, the thickening in the nozzle N cannot be sufficiently refreshed even with the circulation flow rate at that time, and the thickening may proceed with the circulation flow rate at that time. Therefore, when the second abnormality occurs, it is preferable to increase the circulation flow rate of the ink by the process in step S200 as illustrated in FIG. 10. In addition, when a third abnormality occurs due to an ink leaking to an outside of the nozzle N along dust attached on paper or a foreign matter, as illustrated in FIG. 11, it is preferable to increase the negative pressure or decrease the positive pressure by the process in step S300 and to increase the force for ejecting the ink to the common flow path R2.

In the above description, in the present embodiment, the liquid ejecting apparatus 100 includes the piezoelectric element PZ, the plurality of individual flow paths RK each including the pressure chamber CV and the nozzle N for ejecting inks, the common flow path R1 which communicates in common with the plurality of individual flow paths RK and through which the ink is supplied to the plurality of individual flow paths RK, the common flow path R2 which communicates in common with the plurality of individual flow paths RK and through which the ink is discharged from the plurality of individual flow paths RK, the determination unit 3 that determines an ejection state of the nozzle N based on residual vibration generated in the pressure chamber CV after a voltage is applied to the piezoelectric element PZ, the circulation mechanism 6 that circulates the ink from the common flow path R1 to the common flow path R2 via the plurality of individual flow paths RK, and the recovery control portion 40 that executes a recovery process of recovering the ejection state of the nozzle N to a normal state by controlling the circulation mechanism 6 when the ejection state of the nozzle N has an abnormality. The recovery control portion 40 executes different processes according to a type of the abnormality determined by the determination unit 3 as the recovery process.

In this manner, in the present embodiment, the recovery control portion 40 executes different processes according to a type of an abnormality of an ejection state of the nozzle N as a recovery process of recovering the ejection state of the nozzle N to a normal state by controlling the circulation mechanism 6. Therefore, in the present embodiment, the ejection state of the nozzle N can be recovered to the normal state by appropriately adjusting the circulation of the ink in accordance with the type of the abnormality in the ejection state of the nozzle N.

In the present embodiment, the recovery control portion 40 may be configured to execute at least two of a first recovery process of continuing the circulation of the ink by the circulation mechanism 6 when the abnormality determined by the determination unit 3 is a first abnormality caused by mixing of air bubbles in the nozzle N, a second recovery process of increasing a circulation flow rate of the ink by the circulation mechanism 6 when the abnormality determined by the determination unit 3 is a second abnormality caused by thickening of the ink in the nozzle N, and a third recovery process of increasing a ratio of an absolute value of the negative pressure Pout applied to the common flow path R2 to the positive pressure Pin applied to the common flow path R1 when the abnormality determined by the determination unit 3 is a third abnormality caused by a leakage of the ink from the nozzle N, as the recovery process. In this aspect, the ejection state of the nozzle N can be recovered to the normal state by appropriately adjusting the circulation of the ink in accordance with at least two types of the abnormality of the ejection state of the nozzle N, for example, the first abnormality, the second abnormality, and the third abnormality.

In the present embodiment, the recovery control portion 40 may be configured to execute at least the first recovery process of the first recovery process, the second recovery process, and the third recovery process, as the recovery process. In this aspect, when the type of the abnormality in the ejection state of the nozzle N is the first abnormality, the circulation of the ink can be appropriately adjusted to recover the ejection state of the nozzle N to the normal state.

In the present embodiment, in the first recovery process, when a result of determination on the ejection state of the nozzle N by the determination unit 3 after the circulation of the ink by the circulation mechanism 6 is continued for a first time indicates that the first abnormality is continued, the recovery control portion 40 may increase the circulation flow rate. Also in this aspect, when the type of the abnormality in the ejection state of the nozzle N is the first abnormality, the ejection state of the nozzle N can be recovered to the normal state by appropriately adjusting the circulation of the ink. Further, in this aspect, when the type of the abnormality in the ejection state of the nozzle N is the first abnormality, the ejection state of the nozzle N can be prevented from not being recovered to the normal state.

In the present embodiment, in the first recovery process, when the result of the determination on the ejection state of the nozzle N by the determination unit 3 after control for increasing the circulation flow rate is executed a first number of times indicates that the first abnormality continued, the recovery control portion 40 may increase a ratio of the positive pressure Pin applied to the common flow path R1 to the absolute value of the negative pressure Pout applied to the common flow path R2. Also in this aspect, when the type of the abnormality in the ejection state of the nozzle N is the first abnormality, the ejection state of the nozzle N can be recovered to the normal state by appropriately adjusting the circulation of the ink. Further, in this aspect, when the type of the abnormality in the ejection state of the nozzle N is the first abnormality, the ejection state of the nozzle N can be prevented from not being recovered to the normal state, as compared with the aspect described above.

In the present embodiment, the recovery control portion 40 may be configured to execute at least the second recovery process of the first recovery process, the second recovery process, and the third recovery process, as the recovery process. In this aspect, when the type of the abnormality in the ejection state of the nozzle N is the second abnormality, the ejection state of the nozzle N can be recovered to the normal state by appropriately adjusting the circulation of the ink.

In the present embodiment, in the second recovery process, when the result of the determination on the ejection state of the nozzle N by the determination unit 3 after the circulation is continued for a second time by increasing the circulation flow rate indicates that the second abnormality continued, the recovery control portion 40 may further increase the circulation flow rate. Also in this aspect, when the type of the abnormality in the ejection state of the nozzle N is the second abnormality, the ejection state of the nozzle N can be recovered to the normal state by appropriately adjusting the circulation of the ink. Further, in this aspect, when the type of the abnormality in the ejection state of the nozzle N is the second abnormality, the ejection state of the nozzle N is prevented from not being recovered to the normal state.

In the present embodiment, in the second recovery process, the pulse PB, which is a minute vibration waveform to such an extent that the ink is not ejected from the nozzle N, may be applied to the piezoelectric element PZ. In the second recovery process, when the result of the determination on the ejection state of the nozzle N by the determination unit 3 after control for continuing the circulation for the second time by increasing the circulation flow rate is executed the second number of times indicates that the second abnormality is continued, the recovery control portion 40 may increase an intensity of the pulse PB applied to the piezoelectric element PZ. Also in this aspect, when the type of the abnormality in the ejection state of the nozzle N is the second abnormality, the ejection state of the nozzle N can be recovered to the normal state by appropriately adjusting the circulation of the ink. Further, in this aspect, when the type of the abnormality in the ejection state of the nozzle N is the second abnormality, the ejection state of the nozzle N is prevented from not being recovered to the normal state, as compared with the aspect described above.

In the present embodiment, the recovery control portion 40 may be configured to execute at least the third recovery process of the first recovery process, the second recovery process, and the third recovery process, as the recovery process. In this aspect, when the type of the abnormality in the ejection state of the nozzle N is the third abnormality, the ejection state of the nozzle N can be recovered to the normal state by appropriately adjusting the circulation of the ink.

### 2. MODIFICATION EXAMPLE

Each embodiment above can be variously modified. A specific aspect of the modification will be described below. Two or more aspects selected in any manner from the following examples can be appropriately combined with each other within a range not inconsistent with each other. In addition, in the modification examples described below, elements having the same effects and functions as those of the embodiment will be given the reference numerals used in the description above, and each detailed description thereof will be appropriately omitted.

### First Modification Example

In the embodiment described above, the positive pressure Pin and the negative pressure Pout during the printing process executed after the ejection state of the nozzle N is recovered to the normal state by any of the first recovery process, the second recovery process, and the third recovery process may be a final value of the recovery process. Alternatively, the positive pressure Pin and the negative pressure Pout at the time of the printing process may be reset to a predetermined pressure. As described above, in the present modification example as well, the same effect as that of the embodiment described above can be obtained.

### Second Modification Example

In the embodiment and the modification example described above, when the process in step S120 illustrated in FIG. 9 is repeated, the recovery control portion 40 may alternately execute the process of increasing the positive pressure Pin applied to the common flow path R1 and the process of decreasing the negative pressure Pout applied to the common flow path R2. In the same manner, when the process in step S300 illustrated in FIG. 11 is repeated, the recovery control portion 40 may alternately execute the process of increasing the negative pressure Pout applied to the common flow path R2 and the process of decreasing the positive pressure Pin applied to the common flow path R1. As described above, in the present modification example as well, the same effect as that of the embodiment described above can be obtained. In addition, in the present modification example, a change in only one of the positive pressure Pin and the negative pressure Pout can be prevented. Therefore, in the present modification example, the positive pressure Pin or the negative pressure Pout can be prevented from reaching a limit value caused by performance of the circulation mechanism 6 or the like.

### Third Modification Example

In the embodiment and the modification example described above, a case where one ejecting portion D includes two piezoelectric elements PZ, two pressure chambers CV, and one nozzle N is described as an example, and the present disclosure is not limited to such an aspect. For example, one piezoelectric element PZ, one pressure chamber CV, and one nozzle N may be provided for one ejecting portion D. That is, when focusing on the pressure chamber CV and the individual flow path RK, one individual flow path RK may include only one pressure chamber CV As described above, also in the present modification example, the same effect as the effect of the embodiment and modification example described above can be obtained.

### Fourth Modification Example

In the embodiment and the modification example described above, the liquid ejecting apparatus 100 having a serial method in which the carriage 91 at which the liquid ejecting head 1 is mounted is reciprocated in the X-axis direction is described, and the present disclosure is not limited to such an aspect. For example, the liquid ejecting apparatus 100 may have a line method liquid ejecting apparatus in which the plurality of nozzles N are distributed over an entire width of the medium PP. As described above, also in the present modification example, the same effect as the effect of the embodiment and modification example described above can be obtained.

### Fifth Modification Example

The liquid ejecting apparatus 100 described in the embodiment and the modification example described above can be adopted in various devices such as a facsimile machine and a copying machine, in addition to a device dedicated to printing. Moreover, the application of the liquid ejecting apparatus of the present disclosure is not limited to printing. For example, a liquid ejecting apparatus that ejects a solution of a coloring material is used as a manufacturing apparatus that forms a color filter of a liquid crystal display device. In addition, a liquid ejecting apparatus that ejects a solution of a conductive material is used as a manufacturing apparatus that forms a wire or an electrode of a wiring substrate. As described above, also in the present modification example, the same effect as the effect of the embodiment and modification example described above can be obtained.

### 3. APPENDIXES

From the embodiments described above, for example, the following configuration can be ascertained.

According to Aspect 1 that is a preferred aspect, there is provided a liquid ejecting apparatus including: a piezoelectric element; a plurality of individual flow paths each including a pressure chamber and a nozzle for ejecting a liquid; a common supply flow path which communicates in common with the plurality of individual flow paths and through which the liquid is supplied to the plurality of individual flow paths; a common discharge flow path which communicates in common with the plurality of individual flow paths and through which the liquid is discharged from the plurality of individual flow paths; a state determination portion that determines an ejection state of the nozzle, based on residual vibration generated in the pressure chamber after a voltage is applied to the piezoelectric element; a circulation portion that circulates the liquid from the common supply flow path to the common discharge flow path via the plurality of individual flow paths; and a recovery control portion that executes a recovery process of recovering the ejection state of the nozzle to a normal state by controlling the circulation portion when the ejection state of the nozzle has an abnormality, in which the recovery control portion executes different processes according to a type of the abnormality determined by the state determination portion, as the recovery process.

With Aspect 1, the ejection state of the nozzle N can be recovered to the normal state by appropriately adjusting the circulation of the ink in accordance with the type of the abnormality in the ejection state of the nozzle N.

In the liquid ejecting apparatus according to Aspect 2 that is a specific example of Aspect 1, the recovery control portion is configured to execute, as the recovery process, at least two of a first recovery process of continuing the circulation of the liquid by the circulation portion when the abnormality determined by the state determination portion is a first abnormality caused by mixing of an air bubble into the nozzle, a second recovery process of increasing a circulation flow rate of the liquid by the circulation portion when the abnormality determined by the state determination portion is a second abnormality caused by thickening of the liquid in the nozzle, and a third recovery process of increasing a ratio of an absolute value of a negative pressure applied to the common discharge flow path to a positive pressure applied to the common supply flow path when the abnormality determined by the state determination portion is a third abnormality caused by a leakage of the liquid from the nozzle.

With Aspect 2, the circulation of the ink can be appropriately adjusted for at least two of the first abnormality, the second abnormality, and the third abnormality, and the ejection state of the nozzle N can be recovered to the normal state.

In the liquid ejecting apparatus according to Aspect 3 that is a specific example of Aspect 2, the recovery control portion is configured to execute at least the first recovery process of the first recovery process, the second recovery process, and the third recovery process, as the recovery process.

With Aspect 3, when the type of the abnormality in the ejection state of the nozzle N is the first abnormality, the ejection state of the nozzle N can be recovered to the normal state by appropriately adjusting the circulation of the ink.

In the liquid ejecting apparatus according to aspect 4 that is a specific example of Aspect 3, in the first recovery process, when a result of determination on the ejection state of the nozzle by the state determination portion after the circulation portion continues the circulation of the liquid for a first time indicates that the first abnormality is continued, the recovery control portion increases the circulation flow rate.

With Aspect 4 as well, when the type of the abnormality in the ejection state of the nozzle N is the first abnormality, the ejection state of the nozzle N can be recovered to the normal state by appropriately adjusting the circulation of the ink. Further, with Aspect 4, when the type of the abnormality in the ejection state of the nozzle N is the first abnormality, the ejection state of the nozzle N can be prevented from not being recovered to the normal state, as compared with Aspect 3.

In the liquid ejecting apparatus according to Aspect 5 that is a specific example of Aspect 4, in the first recovery process, when a result of determination on the ejection state of the nozzle by the state determination portion after control for increasing the circulation flow rate is executed a first number of times indicates that the first abnormality is continued, the recovery control portion increases a ratio of the positive pressure applied to the common supply flow path to the absolute value of the negative pressure applied to the common discharge flow path.

With Aspect 5 as well, when the type of the abnormality in the ejection state of the nozzle N is the first abnormality, the ejection state of the nozzle N can be recovered to the normal state by appropriately adjusting the circulation of the ink. Further, with Aspect 5, when the type of the abnormality in the ejection state of the nozzle N is the first abnormality, the ejection state of the nozzle N can be prevented from not being recovered to the normal state, as compared with Aspect 4.

In the liquid ejecting apparatus according to Aspect 6 that is a specific example of any one of Aspects 2 to 5, the recovery control portion is configured to execute at least the second recovery process of the first recovery process, the second recovery process, and the third recovery process, as the recovery process.

With Aspect 6, when the type of the abnormality in the ejection state of the nozzle N is the second abnormality, the ejection state of the nozzle N can be recovered to the normal state by appropriately adjusting the circulation of the ink.

In the liquid ejecting apparatus according to Aspect 7 that is a specific example of Aspect 6, in the second recovery process, when a result of determination on the ejection state of the nozzle by the state determination portion after the circulation is continued for a second time by increasing the circulation flow rate indicates that the second abnormality is continued, the recovery control portion further increases the circulation flow rate.

With Aspect 7 as well, when the type of the abnormality in the ejection state of the nozzle N is the second abnormality, the ejection state of the nozzle N can be recovered to the normal state by appropriately adjusting the circulation of the ink. Further, with Aspect 7, when the type of the abnormality in the ejection state of the nozzle N is the second abnormality, the ejection state of the nozzle N can be prevented from not being recovered to the normal state, as compared with Aspect 6.

In the liquid ejecting apparatus according to Aspect 8 that is a specific example of Aspect 7, in the second recovery process, a minute vibration waveform to such an extent that the liquid is not ejected from the nozzle is applied to the piezoelectric element, and in the second recovery process, when a result of determination on the ejection state of the nozzle by the state determination portion after control for continuing the circulation for the second time by increasing the circulation flow rate is executed a second number of times indicates that the second abnormality is continued, the recovery control portion increases an intensity of the minute vibration waveform applied to the piezoelectric element.

With Aspect 8 as well, when the type of the abnormality in the ejection state of the nozzle N is the second abnormality, the ejection state of the nozzle N can be recovered to the normal state by appropriately adjusting the circulation of the ink. Further, with Aspect 8, when the type of the abnormality in the ejection state of the nozzle N is the second abnormality, the ejection state of the nozzle N can be prevented from not being recovered to the normal state, as compared with Aspect 7.

In the liquid ejecting apparatus according to Aspect 9 that is a specific example of any one of Aspects 2 to 8, the recovery control portion is configured to execute at least the third recovery process of the first recovery process, the second recovery process, and the third recovery process, as the recovery process.

With Aspect 9, when the type of the abnormality in the ejection state of the nozzle N is the third abnormality, the ejection state of the nozzle N can be recovered to the normal state by appropriately adjusting the circulation of the ink.

In the liquid ejecting apparatus according to Aspect 10 that is a specific example of Aspect 2, in the first recovery process, when a result of determination on the ejection state of the nozzle by the state determination portion after the circulation of the liquid by the circulation portion is continued for a first time indicates that the first abnormality is continued, the recovery control portion increases the circulation flow rate by increasing the positive pressure and the absolute value of the negative pressure, in the second process, the recovery control portion increases the circulation flow rate by increasing the positive pressure and the absolute value of the negative pressure, in the third process, the recovery control portion increase the ratio by maintaining the positive pressure and increasing the absolute value of the negative pressure, and an amount of increase in absolute value of the negative pressure when the ratio is increased by one time in the third process is larger than an amount of increase in absolute value of the negative pressure when the circulation flow rate is increased by one time in the second process, and the amount of increase in absolute value of the negative pressure when the circulation flow rate is increased by one time in the second process is larger than an amount of increase in absolute value of the negative pressure when the circulation flow rate is increased by one time in the first process.

With Aspect 10, the circulation of the ink can be appropriately adjusted for the first abnormality, the second abnormality, and the third abnormality, and the ejection state of the nozzle N can be recovered to the normal state.

According to Aspect 11, which is a preferred aspect, there is provided a control method for a liquid ejecting apparatus including a piezoelectric element, a plurality of individual flow paths each including a pressure chamber and a nozzle for ejecting a liquid, a common supply flow path which communicates in common with the plurality of individual flow paths and through which the liquid is supplied to the plurality of individual flow paths, a common discharge flow path which communicates in common with the plurality of individual flow paths and through which the liquid is discharged from the plurality of individual flow paths, a state determination portion that determines an ejection state of the nozzle, based on residual vibration generated in the pressure chamber after a voltage is applied to the piezoelectric element, and a circulation portion that circulates the liquid from the common supply flow path to the common discharge flow path via the plurality of individual flow paths, the method including: executing a recovery process of recovering the ejection state of the nozzle to a normal state by controlling the circulation portion when the ejection state of the nozzle has an abnormality, in which the recovery process is a process that differs according to a type of the abnormality determined by the state determination portion.

With Aspect 11, the ejection state of the nozzle N can be recovered to the normal state by appropriately adjusting the circulation of the ink in accordance with the type of the abnormality in the ejection state of the nozzle N.

What is claimed is:

1. A liquid ejecting apparatus comprising:
a piezoelectric element;
a plurality of individual flow paths each including a pressure chamber and a nozzle for ejecting a liquid;
a common supply flow path which communicates in common with the plurality of individual flow paths and through which the liquid is supplied to the plurality of individual flow paths;
a common discharge flow path which communicates in common with the plurality of individual flow paths and through which the liquid is discharged from the plurality of individual flow paths;
a state determination portion that determines an ejection state of the nozzle, based on residual vibration generated in the pressure chamber after a voltage is applied to the piezoelectric element;
a circulation portion that circulates the liquid from the common supply flow path to the common discharge flow path via the plurality of individual flow paths; and
a recovery control portion that executes a recovery process of recovering the ejection state of the nozzle to a normal state by controlling the circulation portion when the ejection state of the nozzle has an abnormality, wherein
the recovery control portion executes different processes according to a type of the abnormality determined by the state determination portion, as the recovery process.

2. The liquid ejecting apparatus according to claim 1, wherein
the recovery control portion is configured to execute, as the recovery process, at least two of
a first recovery process of continuing the circulation of the liquid by the circulation portion when the abnormality determined by the state determination portion is a first abnormality caused by mixing of an air bubble into the nozzle,
a second recovery process of increasing a circulation flow rate of the liquid by the circulation portion when the abnormality determined by the state determination portion is a second abnormality caused by thickening of the liquid in the nozzle, and
a third recovery process of increasing a ratio of an absolute value of a negative pressure applied to the common discharge flow path to a positive pressure applied to the common supply flow path when the abnormality determined by the state determination portion is a third abnormality caused by a leakage of the liquid from the nozzle.

3. The liquid ejecting apparatus according to claim 2, wherein
the recovery control portion is configured to execute at least the first recovery process of the first recovery process, the second recovery process, and the third recovery process, as the recovery process.

4. The liquid ejecting apparatus according to claim 3, wherein
in the first recovery process, when a result of determination on the ejection state of the nozzle by the state determination portion after the circulation portion continues the circulation of the liquid for a first time indicates that the first abnormality is continued, the recovery control portion increases the circulation flow rate.

5. The liquid ejecting apparatus according to claim 4, wherein
in the first recovery process, when a result of determination on the ejection state of the nozzle by the state determination portion after control for increasing the circulation flow rate is executed a first number of times indicates that the first abnormality is continued, the recovery control portion increases a ratio of the positive pressure applied to the common supply flow path to the absolute value of the negative pressure applied to the common discharge flow path.

6. The liquid ejecting apparatus according to claim 2, wherein
the recovery control portion is configured to execute at least the second recovery process of the first recovery process, the second recovery process, and the third recovery process, as the recovery process.

7. The liquid ejecting apparatus according to claim 6, wherein
in the second recovery process, when a result of determination on the ejection state of the nozzle by the state determination portion after the circulation is continued for a second time by increasing the circulation flow rate indicates that the second abnormality is continued, the recovery control portion further increases the circulation flow rate.

8. The liquid ejecting apparatus according to claim 7, wherein
in the second recovery process, a minute vibration waveform to such an extent that the liquid is not ejected from the nozzle is applied to the piezoelectric element, and
in the second recovery process, when a result of determination on the ejection state of the nozzle by the state determination portion after control for continuing the circulation for the second time by increasing the circulation flow rate is executed a second number of times indicates that the second abnormality is continued, the recovery control portion increases an intensity of the minute vibration waveform applied to the piezoelectric element.

9. The liquid ejecting apparatus according to claim 2, wherein
the recovery control portion is configured to execute at least the third recovery process of the first recovery process, the second recovery process, and the third recovery process, as the recovery process.

10. A control method for a liquid ejecting apparatus including
a piezoelectric element,
a plurality of individual flow paths each including a pressure chamber and a nozzle for ejecting a liquid,
a common supply flow path which communicates in common with the plurality of individual flow paths and through which the liquid is supplied to the plurality of individual flow paths,
a common discharge flow path which communicates in common with the plurality of individual flow paths and through which the liquid is discharged from the plurality of individual flow paths,
a state determination portion that determines an ejection state of the nozzle, based on residual vibration generated in the pressure chamber after a voltage is applied to the piezoelectric element, and
a circulation portion that circulates the liquid from the common supply flow path to the common discharge flow path via the plurality of individual flow paths, the method comprising:
executing a recovery process of recovering the ejection state of the nozzle to a normal state by controlling the circulation portion when the ejection state of the nozzle has an abnormality, wherein
the recovery process is a process that differs according to a type of the abnormality determined by the state determination portion.
